(19) United States
(12) Patent Application Publication
(10) Pub. No.: US 2008/0064326 A1
(43) Pub. Date: Mar. 13, 2008

(54) Systems and Methods for Casting Captions Associated With A Media Stream To A User

(76) Inventors: Stephen Joseph Foster, Wildwood, MO (US); Hari Narayan Samrat, St. Louis, MO (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 11/467,004

(22) Filed: Aug. 24, 2006

(51) Int. Cl. H04H 7/00; G10L 21/00

(52) U.S. Cl. 455/3.06; 704/270

(57) ABSTRACT

A system is provided that includes a captioning computer system, a caption caster controller, a caption caster system, and a portable receiver system having an eye piece. The captioning computer system generates a caption stream associated with a radio program and transmits the caption stream to the controller. The controller identifies the program associated with the received caption stream, identifies the caption caster system as being located in the coverage area of the identified program, and distributes the received caption stream to the caption caster system based on its location and the radio program's coverage area. The caption caster system sends the caption stream received from the controller to the portable receiver system via a radio station communication channel, to which each portable receiver system may be selectively tuned such that the captions extracted from the stream may be displayed on the eye piece of the portable receiver system.

### FIELD OF THE INVENTION

The present invention relates in general to audio captioning and subtitling systems. More particularly, the present invention relates to systems and methods for casting captions associated with a broadcast media stream (such as radio broadcasts) to a user having a portable receiver system.

### BACKGROUND OF THE INVENTION

Deaf or hard-of-hearing (D/HH) persons have been excluded from the pleasures of radio listening for a pre-recorded or live radio content broadcast. Such content includes DJ banter music, live talk radio shows (call-in, talk radio, etc.), news broadcasts (local/national news, weather reports, emergencies/alerts, etc.), and sports broadcasts/shows. A D/HH person also needs access to the latest news and information apart from what is broadcast by the traditional radio stations.

Of late, a novel way of news dissemination has been through Real Simple Syndication (RSS) feeds, which is a process for distributing news headlines to subscribers via the world wide web on the Internet. However, RSS feeds are not broadcast to and remotely received by D/HH persons. Instead, a D/HH person must use conventional computer systems for accessing D/HH feeds on the Internet.

A D/HH person also cannot enjoy any of the latest film or movie content releases from Hollywood without attending limited theatres equipped with special captioned screening(s) that require specialized equipment installations or cinema servers to provide captions or subtitles for a film or movie, such as described in US Patent Application Publication No. US 2005/0108026 to Brierre et al.

Therefore, a need exists for systems and methods that overcome the problems noted above and others previously experienced for a D/HH person with captions for any live or pre-recorded content of a radio broadcast, a film showing at a cinema, and news provided via RSS distribution.

### SUMMARY OF THE INVENTION

Systems consistent with the present invention provide a captioning and casting system. The captioning and casting system comprises a captioning computer system, a caption caster controller operatively connected to the captioning computer system, and a caption caster system operatively configured to communicate with the caption caster controller. The captioning computer system includes an audio input device operatively configured to receive an audio stream corresponding to one of a plurality of radio programs broadcast by one or more radio stations. Each of the radio programs corresponds to a respective one of a plurality of program identifiers. Each captioning computer system further includes a first memory device that has a caption generator program that identifies one or more segments of the audio stream, identifies a caption corresponding to each respective segment, embeds each identified caption in a caption stream in association with the program identifier assigned to the one radio program, and transmits the caption stream to the caption caster controller. Each captioning computer system also includes a first processor to run the caption generator program. The caption caster controller is operatively configured to retrieve the program identifier embedded in the caption stream, determine whether the retrieved program identifier is associated with a location of the caption caster system, and distribute the caption stream in a multi-program stream to the caption caster system in response to determining the retrieved program identifier is associated with the caption caster system location.

In one implementation, the captioning and casting system further comprises a portable receiver system having an eye piece and a caption receiver device operatively connected to the eye piece. The caption receiver device is operatively configured to receive the multi-program caption stream from the caption caster system and to selectively display on the eye piece at least one caption embedded in the multi-program caption stream.

Articles of manufacture consistent with the present invention provide a portable receiver system for use in a captioning and casting system. The portable receiver system comprises an eye piece and a caption receiver device operatively connected to the eye piece. The caption receiver includes a user input device and a caption receiving device operatively configured to receive a multi-program caption stream. The caption receiving device corresponds to one of a wireless I/O device, a radio receiver device, a cellular receiver device, or a satellite receiver device. The wireless I/O device is operatively configured to wirelessly connect the caption receiver device to a network to receive the multi-program caption stream from a casting source. The caption receiver further includes a first memory device that has a caption receiver controller program that identifies a packet in the multi-program caption, identifies a program type associated with the packet, identifies an encoding technique associated with the packet, identifies a program ID in the packet, and determines whether the program type corresponds to a radio program type. When it is determined that the program type corresponds to a radio program type and the program ID corresponds to a radio program selected for play on the portable receiver system via the user input device, the caption receiver controller extracts a caption from the packet using the identified encoding technique and sends the caption to the eye piece. The caption receiver also includes a processor to run the caption receiver controller program.

Other systems, methods, features, and advantages of the present invention will be or will become apparent to one with skill in the art upon examination of the following figures and detailed description. It is intended that all such additional systems, methods, features, and advantages be included within this description, be within the scope of the invention, and be protected by the accompanying claims.

### BRIEF DESCRIPTION OF THE DRAWINGS

The accompanying drawings, which are incorporated in and constitute a part of this specification, illustrate an implementation of the present invention and, together with the description, serve to explain the advantages and principles of the invention. In the drawings:

FIG. 1 is a block diagram depicting an exemplary captioning and casting system in accordance with the present invention;

FIG. 2 is a block diagram depicting an exemplary captioning computer system of the captioning and casting system in FIG. 1;

FIG. 3 depicts a flow diagram illustrating an exemplary process performed by a caption generator hosted on the captioning computer system to generate a caption stream corresponding to an audio stream;

FIG. 4 depicts an exemplary structure for a packet of the caption stream generated by the caption generator, in which the packet includes a segment of the audio stream and a caption identified as corresponding to the audio segment in accordance with the present invention;

FIG. 5 depicts an exemplary structure for the caption stream generated by the caption generator in accordance with the present invention;

FIG. 6 depicts another exemplary structure for a packet of the caption stream generated by the caption generator, in which the packet includes a caption identified as corresponding to a segment of the audio stream and a time offset associated with the audio segment and reflecting the time relative to the beginning of the audio stream;

FIG. 7 depicts another exemplary structure for a program header that is included in or precedes the packet of the caption stream in FIG. 6;

FIG. 8 is a block diagram depicting an exemplary embodiment of a caption caster controller of the captioning and casting system in FIG. 1;

FIG. 9 depicts an exemplary structure of each program information record stored in a program database accessible by the caption caster controller to identify a program associated with a received caption stream;

FIG. 10 depicts an exemplary structure of each program schedule record stored in a schedule database accessible by the caption caster controller to identify the location ID and the broadcast schedule of the program associated with the received caption stream;

FIG. 11 depicts an exemplary structure of each location record stored in a location reference database accessible by the caption caster controller to identify the broadcast geographic region corresponding to the location ID of the program associated with the received caption stream;

FIG. 12 depicts an exemplary structure of each caption caster record stored in a caption caster location database, where each caption caster record identifies the location and casting channel type for a respective caption caster system in the captioning and casting system in FIG. 1;

FIG. 13 depicts an exemplary structure of each program content record associated with a respective caption stream and stored in a program content database by the caption caster controller in accordance with the present invention;

FIG. 14 depicts an exemplary structure for a program information packet generated by a caption stream distribution manager of the caption caster controller for distribution to one or more captioning computer systems or one or more portable receiver systems in accordance with the present invention;

FIG. 15 depicts an exemplary structure for a firmware update packet generated by the caption stream distribution manager for distribution to one or more portable receiver systems in accordance with the present invention;

FIG. 16 depicts an exemplary structure for an RSS program packet generated by the caption stream distribution manager for distribution to one or more portable receiver systems in accordance with the present invention;

FIG. 17 depicts an exemplary structure of a multi-program or combined caption stream generated by the caption caster controller from one or more caption streams received from one or more captioning computer systems in accordance with the present invention;

FIGS. 18A-D depict a flow diagram illustrating an exemplary process performed by the caption stream distribution manager of the caption caster controller to identify a caption caster system capable of casting a received caption stream and to generate the multi-program or combined caption stream for distribution to the identified caption caster system;

FIG. 19 is a block diagram depicting an exemplary embodiment of each caption casting system;

FIG. 20 is a block diagram depicting an exemplary embodiment of each portable receiver system;

FIG. 21 depicts a flow diagram illustrating an exemplary process performed by a respective portable receiver system to decode a received multi-program or combined caption stream in accordance with the present invention;

FIG. 22 depicts a flow diagram illustrating an exemplary process performed by the respective portable receiver system when the decoded stream includes a packet having a program or packet type corresponding to a radio program with or without embedded audio;

FIG. 23 depicts a flow diagram illustrating an exemplary process performed by the respective portable receiver system when the decoded stream includes a packet having a program or packet type corresponding to a cinema program; and

FIG. 24 depicts a flow diagram illustrating an exemplary process performed by a respective portable receiver system when the decoded stream includes a packet having a program or packet type corresponding to an RSS program.

### DETAILED DESCRIPTION OF THE INVENTION

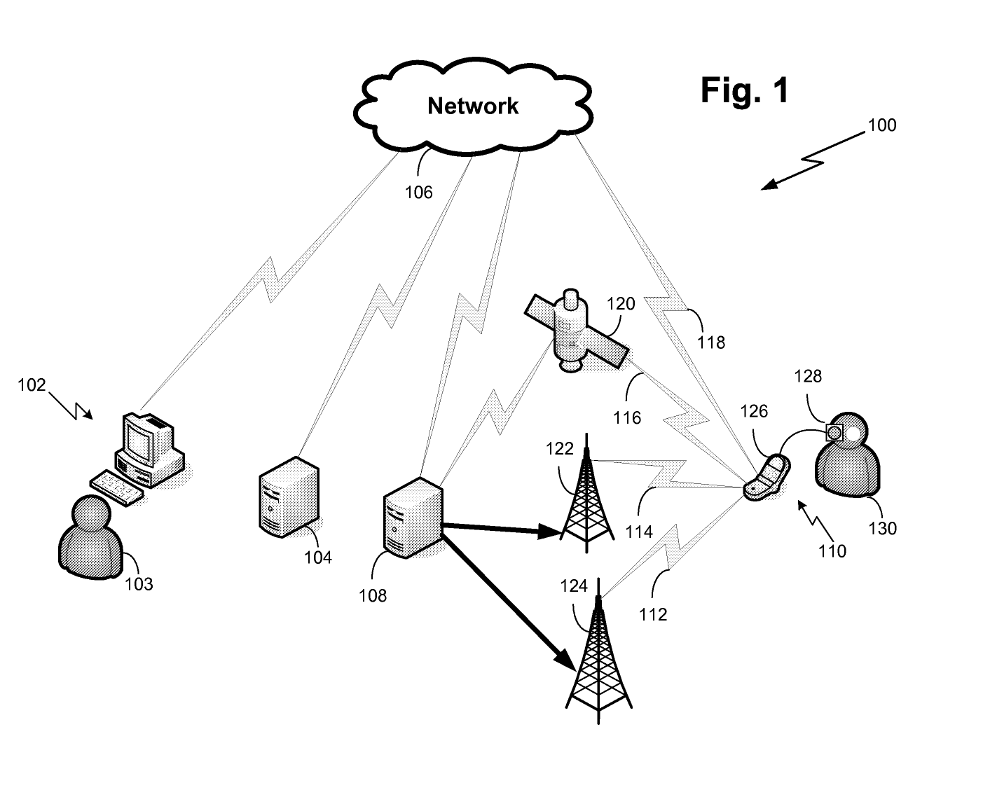

FIG. 1 depicts an exemplary captioning and casting system 100 in accordance with the present invention. The captioning and casting system 100 includes one or more captioning computer systems 102 each of which may be controlled by a respective operator 103 and a caption caster controller 104 operatively connected to each captioning computer system 102 via a network 106. The network 106 may be a private or public communication network, such as a local area network (“LAN”), WAN, Peer-to-Peer, or the Internet, using standard communications protocols. The network 106 may include hardwired and/or wireless branches. In the illustrative embodiment, the network 106 is the Internet.

As shown in FIG. 1, the caption casting controller 104 also includes one or more caption caster systems 108 each operatively connected to the caption caster controller 104 via the network 106, and a portable receiver system 110 operatively configured to receive one or more caption streams broadcast from the one or more caption caster systems 108 via a respective communication channel 112, 114, 116, or 118 associated with the network 106, a satellite uplink 120, a radio broadcast station 122, or a cellular network 124 as further discussed below. The portable receiver system 110 includes a caption receiver device 126 and an eye piece 128 operatively connected to the caption receiver device 126 to enable a user 130 to selectively view a received caption stream in accordance with the present invention.

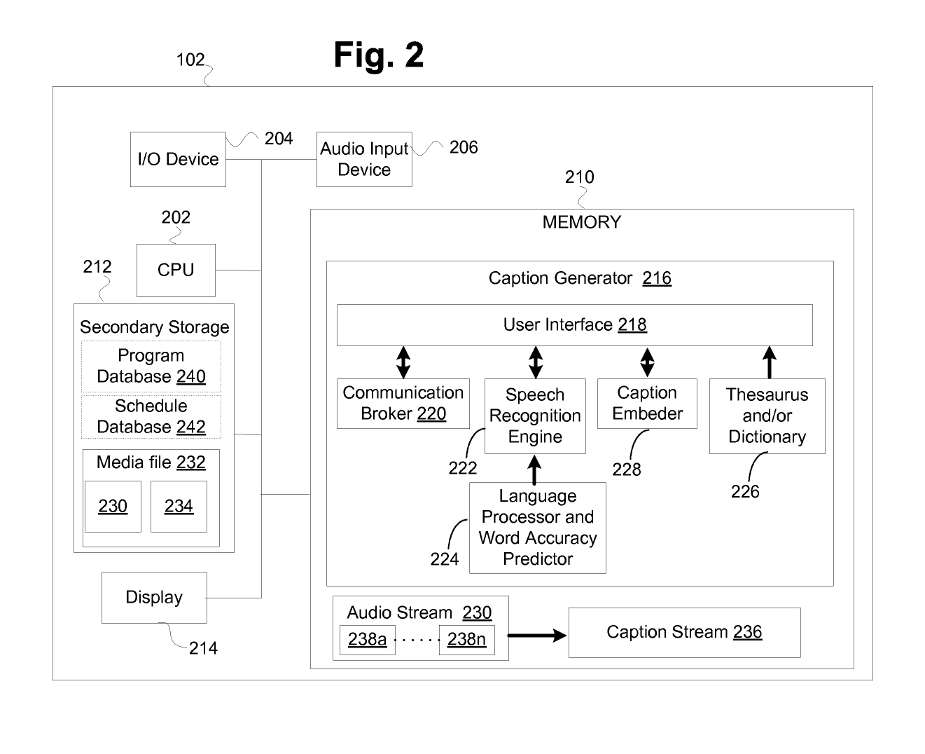

FIG. 2 is a block diagram depicting an exemplary captioning computer system 102 suitable for implementing systems and methods consistent with the present invention. Each captioning computer system 102 may be any general-purpose computer system such as an IBM compatible, Apple, or other equivalent computer. As shown in FIG. 2, each captioning computer system 102 includes a central processing unit (CPU) 202, an input/output (I/O) device 204 (e.g., for a network connection), an audio input device 206 (such as an FM or AM band radio) from which an audio stream 230 may be selectively received by the CPU 202, a memory 210, and a secondary storage device 212. The captioning computer system 102 may further include a display 214 and user input devices, such as a keyboard or a mouse (not shown in figures).

The memory 210 stores a caption generator 216 program that is called up by the CPU 202 from the memory 210 as directed by the CPU 202 to perform operations as described herein below. The caption generator 216 includes a user interface 218 module and a communication broker 220 module, a speech recognition engine 222, a language processor and word accuracy predictor 224 module, a thesaurus and/or dictionary 226 module and a caption embedder 228 module. The communication broker 220 module is operatively connected to the user interface 218 and operatively configured to manage each communication between the captioning computer system 102 and other components of the system 100 on the network 106, such as the caption caster controller 104. The language processor and word accuracy predictor 224 module enables the speech recognition engine 222 to recognize the language of an audio stream 230 and to increase the probability of selecting a word or caption to associate with a segment (e.g., 238a in FIG. 2) of the audio stream 230 so that the speech recognition engine 222 may convert the audio stream 230 into corresponding text (e.g., words or captions associated with respective segments 238a-238n of the audio stream 230). The speech recognition engine 222 may be a Dragon Naturally Speaking™ program commercially available from Nuance Corp. or other known speech recognition engine. The language processor and word accuracy predictor 224 may be a Natural Language Processor™ program operatively coupled with a Speech Analytics™ program, both commercially available from Sonum Technologies, or other known language processor program. The thesaurus and/or dictionary 226 module is operatively connected to the speech recognition engine 222 via the user interface 218 so that the operator may be prompted by the caption generator 216 to confirm or correct a caption identified by the caption generator 216 as corresponding to a segment 238a or 238n of the audio stream 230.

The audio stream 230 may be received via the audio input device 206, which may include an analog to digital converter (not shown in the figures) to convert the selected audio stream 230 input (e.g., a selected FM or AM radio channel) from an analog format to a digital format for further processing. Alternatively, the audio stream 230 may be received via the network 106 from a radio station, a TV station, movie studio, or other media source (not shown in figures). In one implementation, the audio stream 230 is to be provided with or incorporated in a media file 232 received from the media source. The media file 232 also may include a video stream 234 associated with the audio stream 230. In this implementation, the caption generator 216 is operatively configured to parse or separate the audio stream 230 from the video stream 234 so that the audio stream 230 may be processed as further described herein.

The caption embedder 228 is operatively configured to embed a word or caption identified by the speech recognition engine 222 (with or without the corresponding segment 238a or 238n of the audio stream 230) into a caption stream 236, which may thus be formed or extended by the caption generator 216.

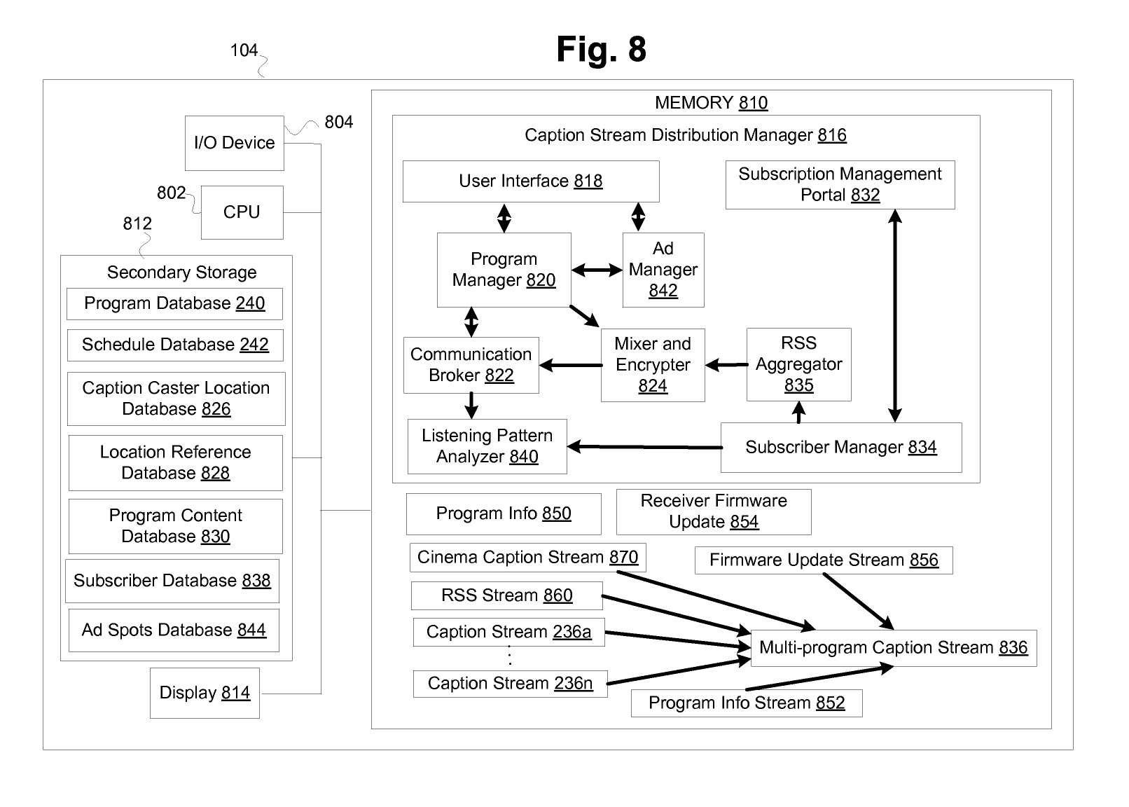

As shown in FIG. 2, each captioning computer system 102 also may store in secondary storage device 212 a program database 240 that includes information about the source (radio station) of the audio stream 230, such as a Program ID assigned to each program from the source, a respective program descriptor providing information about the program, and a program duration for pre-recorded programs. Each captioning computer system 102 also may store a schedule database 242 that identifies a starting time when the respective program was or will be transmitted by the source. As further described below, each captioning computer system 102 uses the program database 240 and schedule database 242 to embed respective program information (e.g., Program ID) in the caption stream 236 corresponding to the audio stream 230 associated with the program being processed by the respective captioning computer system 102. The program database 240 and the schedule database 242 may be shared with the caption caster controller 104 via the network 106. In this implementation, the caption caster controller 104 may receive and distribute duplicates of the program database 240 and the schedule database 242 to each captioning computer system 102. Alternatively, the program database 240 and the schedule database 242 may be stored on the caption caster controller 104. In this implementation, the caption caster controller 104 is operatively configured to provide each captioning computer system 102 with program information (e.g., Program Info 850 in FIG. 8) from the program database 240 and the schedule database 242 so that each captioning computer system 102 is able to generate a caption stream 236 as described in further detail below. In this implementation, the caption caster controller 104 also may periodically broadcast the program information 850 to each receiver system 110 via one or more caption caster systems 108 as discussed in further detail herein.

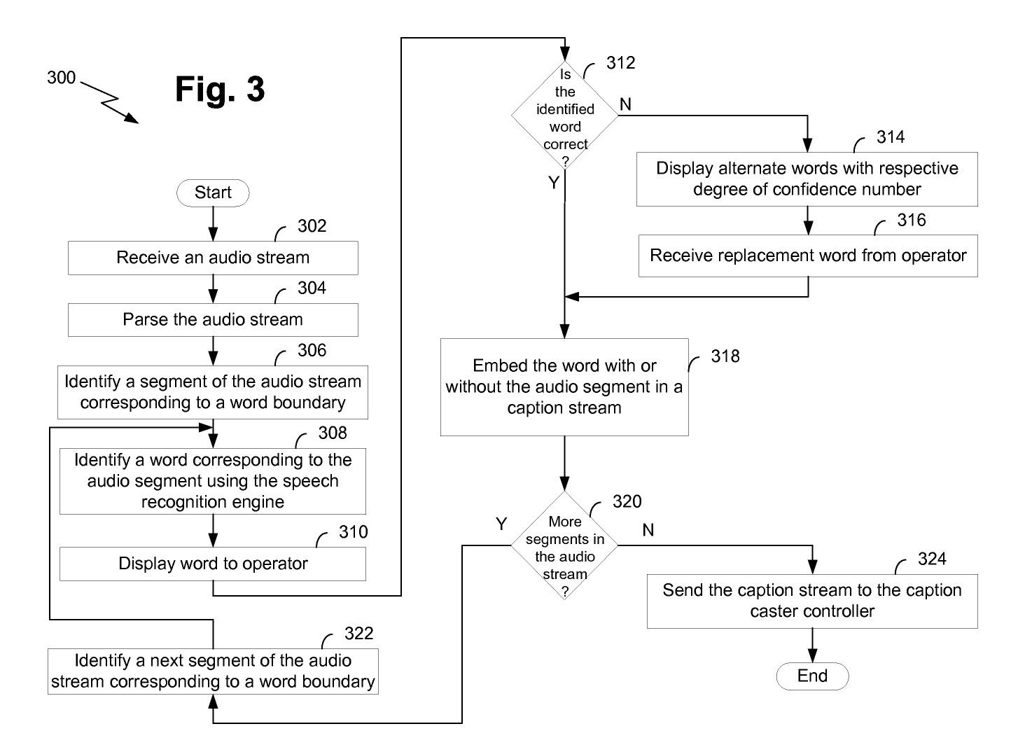

FIG. 3 depicts a flow diagram illustrating an exemplary process 300 performed by the caption generator 216 to generate a caption stream 236 corresponding to an audio stream 230. Initially, the caption generator 216 receives an audio stream 230 (step 302). The audio stream 230 may be received via the audio input device 206 or the network 106. In addition, if the audio stream 230 is pre-recorded, the audio stream 230 may be provided to the captioning computer system 102 as a media or audio file on a removable media device, such as a compact disk or flash memory device (not shown in figures). In one implementation, secondary storage device 212 may correspond to a removable media device for storing the audio stream 230.

Next, the caption generator 216 parses the audio stream (step 304) and identifies a first segment (e.g., 238a) of the audio stream 230 corresponding to a word boundary (step 306). The caption generator 216 may identify a word boundary of the audio stream 230 based on an amplitude change, a frequency, or other characteristic of the audio stream 230. The caption generator 216 then identifies a word corresponding to the audio segment 238a or 238n using the speech recognition engine 222 (step 308). The caption generator 216 displays the identified word to the operator 103 of the respective captioning computer system 102 (step 310) and then determines whether the identified word is correct (step 312) via the actuation by the operator 103 of either a first key or radio button on the user interface 218 designated for approval of the identified word or a second key or radio button on the user interface 218 designated for disapproval of the identified word (neither key nor radio button shown in figures).

If the identified word is not correct, the caption generator 216 displays one or more alternate words in association with a respective degree of confidence number (step 314). For example, the caption generator 216 may prompt the language processor and word accuracy predictor 224 to identify the probability that the first of the alternative words is the word that correctly corresponds to the current segment 238a or 238n of the audio stream 230 based on linguistic patterns or characteristics associated with a speaker or source of the audio stream 230 or other known speech recognition techniques. The caption generator 216 may then receive a replacement word from the operator 103 (step 316) corresponding to one of the displayed alternative words or another word typed into the captioning computer system by the operator 103. The caption generator 216 identifies the replacement word as the identified word before continuing processing.

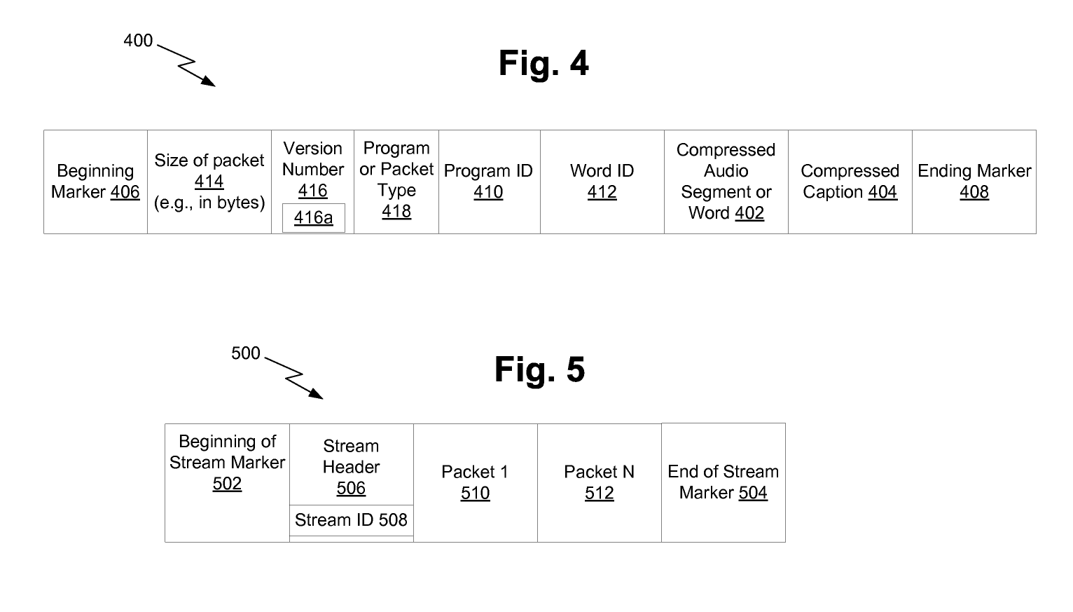

If the word identified by the caption generator 216 is correct or a replacement word has been received, the caption generator 216 next embeds the word with or without the audio segment 238a or 238n in a caption stream 236 (step 318). In one implementation shown in FIG. 4, the caption generator 216 embeds or encodes each word by compressing the audio segment (or audio word) 238a or 238n using a known audio compression format (such as MP3, Adaptive Multi-Rate Wideband Codec (AMR-WB), or AccPlus) and then inserting the compressed audio segment or word 402 into a packet 400 along with the corresponding caption 404, which may be compressed using the same technique used to compress each audio segment 238a-238n. The packet 400 may be one of a plurality of packets inserted by the caption generator 216 into the caption stream 236 as further described herein. Each packet 400 may be distinguished from a preceding or subsequent packet in the caption stream 236 by a beginning marker 406 and an ending marker 408.

In this implementation, the packet 400 may include a program ID 410, which is a unique identifier of the radio or media program associated with the audio stream 230 and with the corresponding caption stream 236 produced by the caption generator 216. The packet 400 also may include a word ID 412, which is a unique number assigned to each compressed audio segment or word 402 and corresponding caption 404 inserted into the caption stream 236. In one implementation, the caption generator 216 assigns a zero as the word ID 412 for the first audio segment 238a and increments the word ID 412 by one for the next audio segment 238n to be inserted in a respective packet 400 in the caption stream 236. Each packet 400 also may include a packet size 414 to reflect the length in bytes or bits of the respective packet 400. In addition, each packet 400 also may include a version number 416 that includes a first portion 416a that identifies the encoding technique (e.g., MP3, AMR-WB, or other encoding technique) used to encode each audio segment or word 238a-238n or 402 and each corresponding caption 404 in the packet 400. Each packet 400 also includes a program or packet type 418 associated with the packet 400. The program or packet type 418 may identify a captioned broadcast radio program with audio (e.g., with embedded audio segment or word 402) or without audio (e.g., a time synched caption 602). As further discussed below, the caption caster controller 104 may generate or route a packet 400 or 600 that includes a program or packet type 418 to identify the associated program or packet as a captioned cinema program (e.g., a time synched caption 602 without audio), an RSS program captioned from an RSS feed or source, Program Info 850 for each receiver system 110, or a receiver firmware update 854 for each portable receiver system 110 as further discussed below.

FIG. 5 depicts one exemplary implementation 500 of the caption stream 236 in accordance with the present invention. As shown in FIG. 5, the audio and caption stream 500 includes a beginning of stream marker 502 and an end of stream marker 504 to enable the current caption stream 236 to be distinguished from a preceding caption stream 236 and a subsequent caption stream 236. Each audio and caption stream 500 may include a stream header 506 along with each packet 510 and 512 inserted into the stream 500. The stream header 506 may include a stream ID 508, which is used by the caption caster controller 104 and each portable receiver system 110 to differentiate one caption stream 236a or 500 from another caption stream 236n or 500 in a multi-program or combined caption stream 836 or when the streams are stored and/or retrieved by the caption caster controller 104 or each portable receiver system 110.

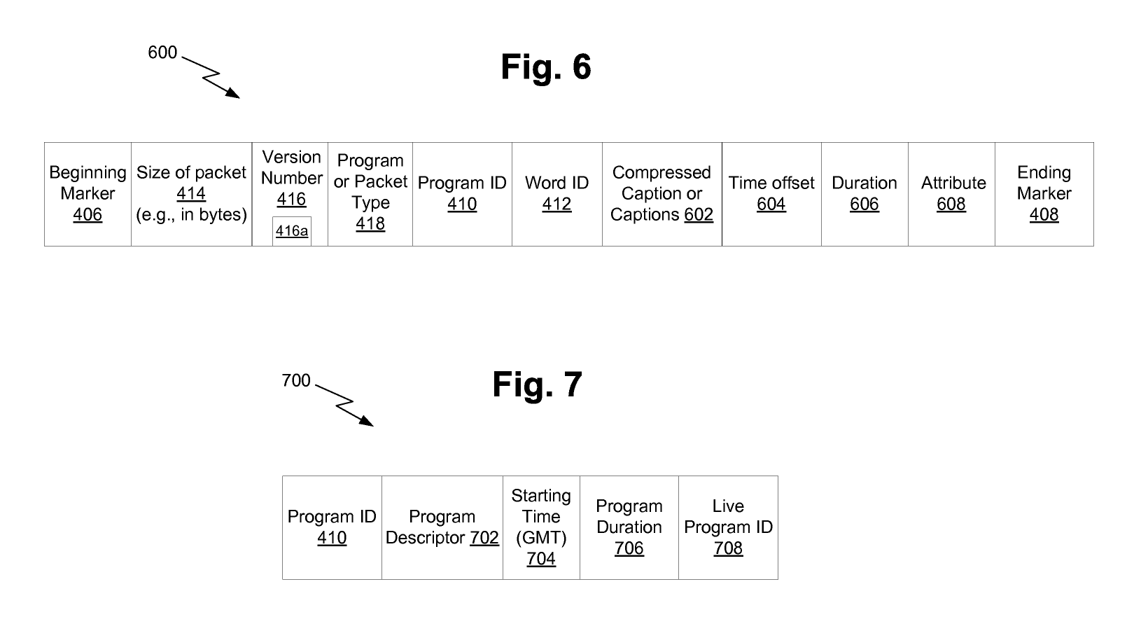

In another implementation shown in FIG. 6, the caption generator 216 does not embed or encode each audio segment but rather encodes one or more captions 602 corresponding to a respective audio segment 238a or 238n in a packet 600 along with an associated time offset 604 and an associated duration 606. In this implementation, the audio stream 230 may be separately transmitted to and received (if at all) by a respective portable receiver system 110 in accordance with the present invention. The time offset 604 is the time offset relative to the beginning of the program specified by the program ID 410 in the packet 600 at which the respective caption 602 should be displayed by each portable receiver system 110 that receives and decodes the caption stream 236 in accordance with the present invention. The duration 606 identifies to each portable receiver system 110 the length of time for displaying the respective caption 602. Each caption 602 may be compressed using a known compression technique such as MP3. Each packet 600 may be one of a plurality of packets 510 and 512 in the caption stream 236 in which each packet 600 may be distinguished from a preceding or subsequent packet in the caption stream 236 by a beginning marker 406 and an ending marker 408.

Consistent with the packet 400, the packet 600 also may include a word ID 412, a packet size 414, a version number 416, and a program or packet type 418 associated with the packet 600. The version number 416 includes a first portion 416a identifying the encoding technique (e.g., MP3, AMR-WB, or other encoding technique) used to encode each caption 602 in the packet 600. In the implementation shown in FIG. 6, the caption generator 216 of each captioning computer system 102 or the program manager 820 of the caption caster controller 104 in FIG. 8 may set the program or packet type 418 to identify the packet 600 as being associated with a captioned broadcast radio program without audio or a captioned cinema program (e.g., a time synched caption 602 without audio).

As shown in FIG. 6, the packet 600 also may include one or more attributes 608 of the audio segment 238a or 238n corresponding to the caption 602. For example, the attribute 608 may be a voice type identifier that indicates whether the audio segment 238a or 238n corresponding to the caption 602 is associated with a male voice, a female voice, music or other type of audio type. Alternatively or in addition to the attribute 608 may be a voice descriptor that reflects a gruff male voice, an accented voice, or other voice characteristic.

In addition, each packet 600 in this caption stream implementation may include or be preceded by a program header 700 as shown in FIG. 7. Each program header 700 may include a program ID 410, a program descriptor 702 that provides information about the respective program, a starting time 704 (e.g., in Greenwich mean time (GMT)) for the respective program, and a program duration 706. Each program header 700 also may include a live program ID 708 that indicates whether the respective program is a live event or of limited time duration. The program duration 706 is set to zero by the caption generator 216 for a live event.

In yet another implementation, the caption generator 216 may embed and encode each caption corresponding to each identified audio segment (or audio word) 238a or 238n in a caption stream 236 using a known streamable encoding format or technique, such as the MPEG-4 Part 17 standard or the Ogg Writ standard, which specifies that a text-phrase codec be used with the known Ogg encapsulation format. As discussed herein, the caption generator 216 sets the first portion 416a of the version number 416 of each packet 400 or 600 in the caption stream 236 or 500 to identify the encoding format or technique to the caption caster controller 104 and each portable receiver system 110 that decodes the packet 400 or 600 in the respective caption stream 236 or 500.

Returning to FIG. 3, after embedding the word or caption 404 or 602 in the caption stream 236, the caption generator 216 determines whether there are more segments (e.g., 238n) in the audio stream 230 (step 320). If there are more segments in the audio stream 230, the caption generator 216 identifies a next segment (e.g., 238n) of the audio stream 230 corresponding to a word boundary (step 322) and continues processing at step 308.

If there are no more segments in the audio stream 230, the caption generator 216 sends the caption stream 236 to the caption caster controller 104 (step 324) before ending processing. Each captioning computer system 102 may have an operating system (not shown in figures) and CPU 202 that supports multi-thread processing such that the caption generator 216 may perform the process 300 on multiple audio streams 230 from one or more sources substantially simultaneously or in parallel.

In one implementation, the operator 103 may augment or replace the process 300 performed by the caption generator 216 by listening to the audio stream 230 as it is being received by the caption generator 216 (step 302), manually parsing the audio stream (step 304), identifying a first segment (e.g., 238a) of the audio stream 230 corresponding to a word boundary (step 306), and identifying a word corresponding to the audio segment 238a or 238n by listening or using the speech recognition engine 222 (step 308). The operator may use a keyboard or other input device (not shown in the figures) to identify the word to the caption generator 216 and prompt the caption generator 216 to embed the captioned word with or without the audio segment 238a or 238n in a packet 400 or 600 of the caption stream 236 (step 318) in accordance with the present invention and to prompt the caption generator 216 to send the caption stream 236 to the caption caster controller 104 (step 324).

Turning to FIG. 8, a block diagram depicting an exemplary embodiment of the caption caster controller 104 is shown. The caption caster controller 104 may be any general-purpose computer system such as an IBM compatible, Apple, or other equivalent computer operatively configured as described herein. As shown in FIG. 8, the caption caster controller 104 includes a central processing unit (CPU) 802, an input/output (I/O) device 804 (e.g., for a network connection), a memory 810, and a secondary storage device 812. The caption caster controller 104 may further include a display 814 and user input devices, such as a keyboard or a mouse (not shown in figures).

The memory 810 stores a caption stream distribution manager 816 program that is called up by the CPU 802 from the memory 810 as directed by the CPU 802 to perform operations as described below. As discussed in further detail below, the caption stream distribution manager 816 is operatively configured to receive the caption streams 236a-236n from each captioning computer system 102 and route the received caption streams 236a-236n to a respective caption caster system 108 based on the respective program associated with each received caption stream 236a-236n and the location of each caption caster system 108. For example, a first radio station (not shown in figures) located in or around St. Louis may broadcast a first radio program (e.g., a news or talk show program) on a known radio channel to an area in or around St. Louis. The caption stream distribution manager 816 is operatively configured to recognize a caption stream 236a or 236n associated with the first radio program and to route the associated caption stream 236a or 236n to one of the caption caster systems 108 located near or within the same area as the first radio station that broadcast the first radio program. In one implementation, the caption stream distribution manager 816 is operatively configured to combine each caption stream 236a-236n associated with a respective program scheduled for broadcast in the same location into a multi-program caption stream 836 that is routed to the one caption caster system 108 located near or within the same location.

As shown in FIG. 8, the caption stream distribution manager 816 includes a user interface 818, a program manager 820 module operatively connected to the user interface 818, a communication broker 822 module operatively connected to the program manager 820, and a mixer and encrypter 824 module operatively connected between the program manager 820 and the communication broker 822. The program manager 820 is operatively connected to the program database 240, the schedule database 242, a caption caster location database 826, a location reference database 828, and a program content database 830, each of which may be stored in secondary storage of the casting caption controller 104. To coordinate the generation of caption streams 236a-236n by the captioning computer systems 102, the program manager 820 may distribute a copy of the program database 240 and the schedule database 242 to each captioning computer system 102 or periodically distribute program information 850 derived from each database 240 and 242 to the respective captioning computer system 102. The program manager 820 is also operatively configured to periodically distribute program information 850 derived from the program database 240 and the schedule database 242 to each portable receiver system 110 via one or more caption caster systems 108 as discussed in further detail below.

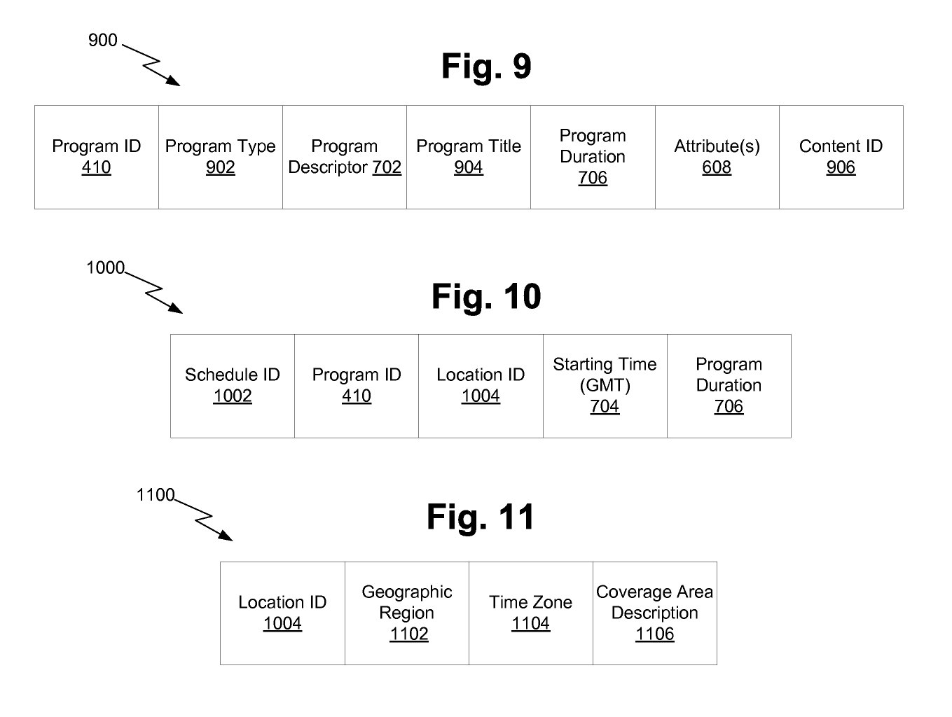

The program database 240 stores a program information record 900 in FIG. 9 for each program associated with an audio stream 230 to be processed by the captioning and casting system 100 in accordance with the present invention. As shown in FIG. 9, the format for each program information record 900 stored in the program database 240 may include a program ID 410, a program type 902, a program descriptor 702, a program title 904, a program duration 706, one or more attributes 608, and a content ID 906. The program ID 410 is the unique identifier of the radio or media program associated with the audio stream 230 (or RSS stream 860 as discussed below) to be processed by the captioning and casting system 100 in accordance with the present invention. The program type 902 identifies the respective program as being a captioned broadcast radio program with audio (e.g., with embedded audio segment or word 402) or without audio (e.g., a time synched caption 602), a captioned cinema program (e.g., a time synched caption 602 without audio), or an RSS program captioned from an RSS feed or source.

The program descriptor 702 includes a description of the respective program. The program title 904 identifies a title of the program to be displayed on the eye piece 128 of the portable receiver system 110 when a caption stream 236a-236n is decoded by the portable receiver system in accordance with the present invention. The content ID 906 points to or is an index to a respective program content record 1300 in FIG. 13 in the program content database 830 where captioned program content 1302 (e.g., each caption 404 in a respective caption stream 236a or 236b or multi-program caption stream 836) associated with a respective program is stored by the caption stream distribution manager 816. As shown in FIG. 13, each program content record 1300 also may include one or more content attributes 1304, which may identify the copyright owner or other copyright information required for Digital Rights Management.

As shown in FIG. 10, the schedule database 242 stores a program schedule record 1000 for each program associated with an audio stream 230 to be processed by the captioning and casting system 100 in accordance with the present invention. Each program schedule record 1000 includes information about the frequency and time a respective program is aired. The format for each program schedule record 1000 stored in the schedule database 242 may include a schedule ID 1002, a program ID 410, a location ID 1004, a starting time 704 for the respective program, and a program duration 706. The schedule ID 1002 is a unique identifier associated the program ID 410, each of which may be used by the program manager 820 to locate the respective program schedule record 1000 in the schedule database 242. The location ID 1004 is a unique identifier associated with a location record 1100 in FIG. 11 stored in the location reference database 828, where the location record 1100 includes information to identify the location coverage area where a respective program (e.g., the program corresponding to the program ID in the program schedule record 1000) will be aired or broadcast by a radio station or other media source.

As shown in FIG. 11, the format for each location record 1100 stored in the location reference database 828 may include a location ID 1004, a geographic region 1102, such as one or more states or a portion thereof, a time zone 1104 associated with the geographic region 1102, and a coverage area description 1106, which may include information to further define or distinguish the geographic region 1102.

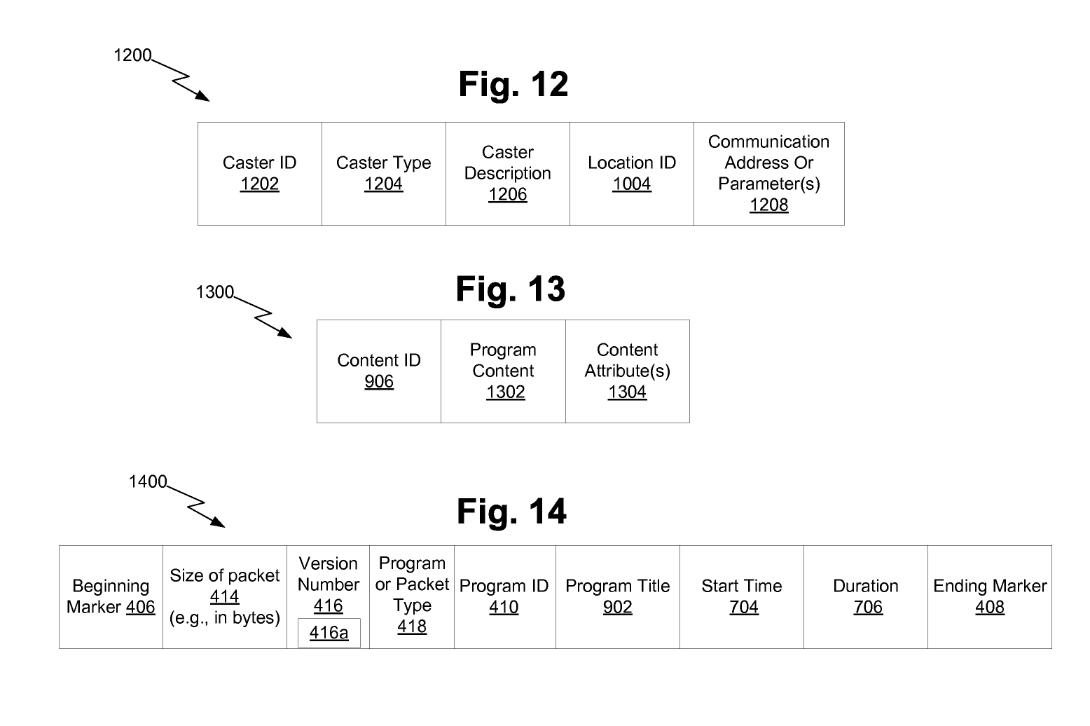

The caption caster location database 826 stores a caption caster record 1200 in FIG. 12 for each caption caster system 108 that is available to receive and cast a caption stream 236a or 236n or a multi-program caption stream 836 in accordance with the present invention. As shown in FIG. 12, the format for each caption caster record 1200 stored in the caption caster location database 826 may include a caster ID 1202, a caster type 1204, a caster description 1206, a location ID 1004, and a communication address or parameter(s) 1208. The caster ID 1202 is a unique identifier for the respective caption caster system 108 associated with the caption caster record 1200. The caster type 1204 identifies each communication channel 112, 114, 116, or 118 (e.g., a cellular network 124 channel, a radio broadcast station 122 channel or sideband, a satellite uplink 120 channel, or network 106 channel) available to the respective caption casting system 108 for casting a caption stream 236a or 236n or multi-program caption stream 836 received from the caption caster controller 104. The caster description 1206 includes information to further define the respective caption casting system 108. The location ID 1004 is used by the program manager 820 to identify the location record 1100 associated with the respective caption casting system 108. The communication address or parameter(s) 1208 identifies the network 106 address and/or other communication parameter required to communicate with the respective caption casting system 108. The program manager 820 is operatively configured to assign one or more of the caption casting systems 108 to receive and cast a caption stream 236a or 236n or a multi-program caption stream 836 based on the location ID 1004 and the caster type 1204 identified in the caption caster record 1200 associated with the respective caption casting system 108.

As previously noted, the program manager 820 is operatively configured to derive program information 850 from the program database 240 and the schedule database 242 and distribute the program information 850 in one or more program information packets in a program information stream 852 in FIG. 8 to each portable receiver system 110 via one or more caption caster systems 108 so that each portable receiver system 110 is adapted to associate a received packet (e.g., packet 400 or 600) with a corresponding captioned program (e.g., a broadcast radio program, a cinema program, or an RSS program) based on the program ID 410 in the respective packet. FIG. 14 depicts one implementation of a program information packet 1400 generated by the program manager 820 to distribute the derived program information 850. As shown in FIG. 14, each program information packet 1400 may include a beginning marker 406 and an ending marker 408 to distinguish each packet (e.g., packet 400, 600, or 1400) from a preceding or subsequent packet in a caption stream 236a or 236n or a multi-program caption stream 836. Consistent with packets 400 and 600, each program information packet 1400 also may include a program ID 410, a packet size 414, a version number 416, a program or packet type 418, a program title 902, a start time 704, and a duration 706 associated with the captioned program. In this implementation of a program information packet 1400, the program or packet type 418 identifies the program type corresponding to the program ID. For example, the program or packet type 418 in the program information packet 1400 may be set by the program manager 820 of the caption caster controller 104 to indicate to each portable receiver system 110 that the packet 1400 is associated with a captioned broadcast radio program with audio (e.g., with embedded audio segment or word 402) or without audio (e.g., a time synched caption 602), a captioned cinema program (e.g., a time synched caption 602 without audio), or an RSS program captioned from an RSS feed or source.

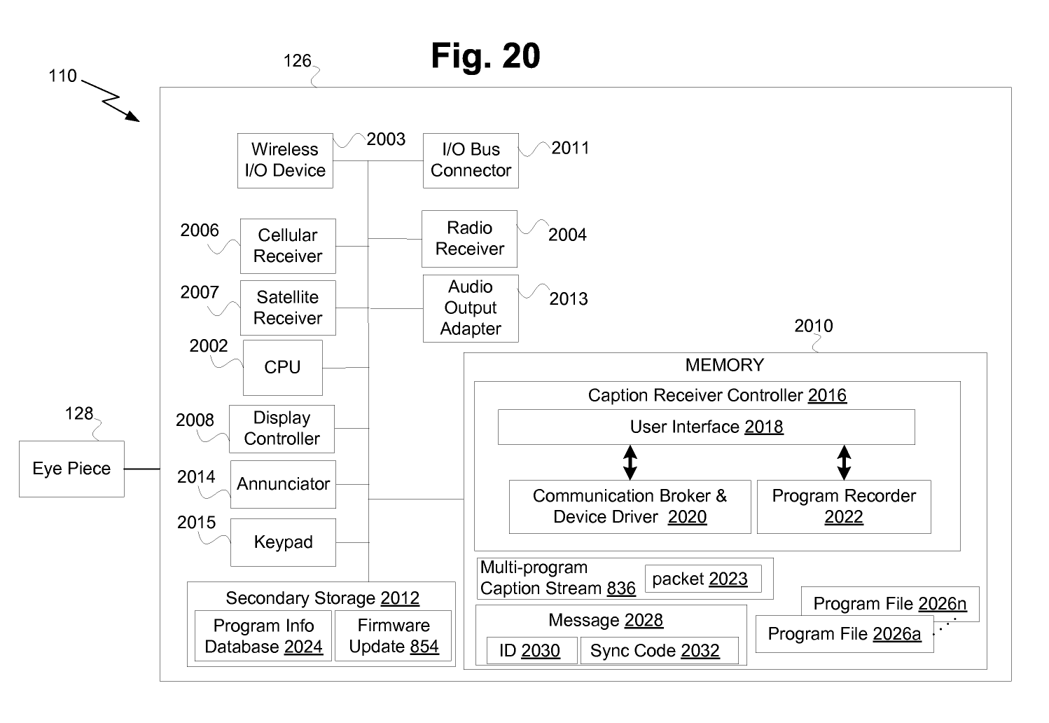

Each portable receiver system 110 stores each received program information packet 1400 in a local program info database (e.g., database 2024 in FIG. 20). When a portable receiver system 110 receives a packet 400 or 600 in a caption stream 236a-236n or a multi-program caption stream 836, the portable receiver system 110 is able to recognize the program type associated with the packet 400 or 600 and process the packet accordingly as further discussed below.

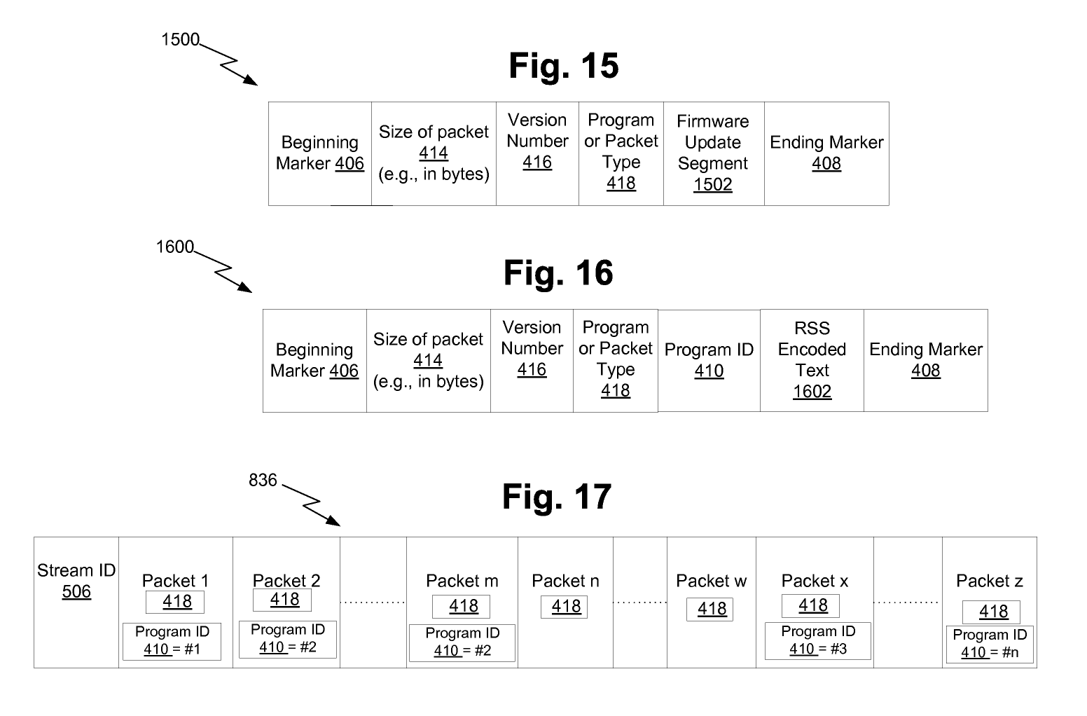

The program manager 820 is further operatively configured to receive a receiver firmware update 854 module from a system administrator operating the caption caster controller 104 or via a message (not shown in figures) across the network 106. The receiver firmware update 854 module provides a decoding procedure for each new encoding technique employed by each captioning computer system 102 or the caption caster controller 104 as reflected by the first portion 416a of the version number 416 in a packet 400 or 600. The program manager 820 is operatively configured to distribute each receiver firmware update 854 in one or more firmware update packets 1500 in a firmware update stream 856 or a multi-program caption stream 836 to each portable receiver system 110 in accordance with the present invention. Thus, each portable receiver system 110 is able to receive a multi-program caption stream 836 having packets 400 or 600 encoded using different encoding techniques. As shown in FIG. 15, each firmware update packet 1500 may include a beginning marker 406 and an ending marker 408 to distinguish each packet (e.g., packet 400, 600, 1400, or 1500) from a preceding or subsequent packet in a caption stream 236a or 236n or a multi-program caption stream 836. Consistent with other packets 400, 600, and 1400, each firmware update packet 1500 may include a packet size 414, a version number 416, and a program or packet type 418. In this implementation of a firmware update packet 1500, the program or packet type 418 identifies the packet type as a firmware update so that each portable receiver system 110 may process each packet 1500 accordingly as further described below. Each firmware update packet 1500 further includes a firmware update segment 1502, which may be a portion or all of the receiver firmware update 854 module depending on whether the packet size 414 is able to accommodate the entire receiver firmware update 854.

Returning to FIG. 8, the communication broker 822 module functions as a communication gateway on the network 106 for the caption caster controller 104. The communication broker 822 is operatively configured to manage each communication between the caption caster controller 104 and each captioning computer system 102, each caption caster system 108, and each portable receiver system 110 when operatively connected to the network 106. The communication broker 822 is operatively configured to maintain and manage the status of the communication connection to each captioning computer system 102, each caption caster system 108, and each portable receiver system 110. In particular, when communication to another component (e.g., a captioning computer system 102, a caption caster system 108, or a portable receiver system 110) fails on the network 106, the communication broker 822 may then communicate with the component via a dial-up (wired or wireless) modem or other I/O device.

Continuing with FIG. 8, the caption stream distribution manager 816 also may include a subscription management portal 832 application or web-based user interface, a subscriber manager 834 module operatively configured to respond to user or subscriber access to the subscription management portal 832 and an RSS aggregator 835 module operatively connected between the subscriber manager 834 and the mixer and encrypter 824. A user or subscriber to the system 100 may access the subscription management portal 832 via a standard client computer (not shown in the figures) connected to the network 106. The subscription management portal 832 is operatively configured to allow a user or subscriber to enter user information (e.g., a user ID and password) for authentication by the subscriber manager 834 using a standard authentication technique and, once authenticated, to enter radio content source selections (e.g., National Public Radio or other radio station or a user identified program broadcast by a user identified radio station) and/or RSS content source selections (e.g., the Internet address for New York Times RSS distribution) for viewing via a portable receiver system 110 associated with the user or subscriber in accordance with the present invention. In one implementation, the subscriber manager 834 maintains and manages a record or an account in a subscriber database 838 for each subscriber to the system 110. The subscriber database 838 may be stored in the secondary storage device 812 of the caption caster controller 104 or on another dedicated computer or server (not shown in the figures) across the network 106. The subscriber manager 834 may store the subscriber's radio content source selections and RSS content source selections in the account or record in the subscriber database 838 associated with the respective subscriber.

The RSS aggregator 835 is operatively configured to identify each RSS content source selections of each subscriber in the subscriber database 838, request to receive an RSS feed (not shown in figures) in accordance with each identified RSS content source selection, generate an RSS stream 860 corresponding to the RSS feed and provide the mixer and encrypter 824 with each RSS stream 860 so that the RSS streams 860 may be distributed in a multi-program or combined caption stream 836 to a portable receiver system 110 in accordance with the present invention.

In one implementation, each RSS stream 860 may include one or more RSS feed packets 1600 as shown in FIG. 16. Each RSS feed packet 1600 may include a beginning marker 406 and an ending marker 408 to distinguish each packet (e.g., packet 400, 600, 1400, 1500, or 1600) from a preceding or subsequent packet in a caption stream 236a or 236n or a multi-program caption stream 836. Consistent with other packets 400, 600, 1400, and 1500, each RSS feed packet 1500 may include a packet size 414, a version number 416, and a program or packet type 418. In this implementation of an RSS feed packet 1600, the program or packet type 418 identifies the packet type as an RSS feed so that each portable receiver system 110 may process each packet 1600 accordingly as further described below. Each RSS feed packet 1600 further includes RSS encoded text 1602 corresponding to text received from the respective RSS feed associated with the identified RSS content source selection.

The mixer and encrypter 824 is operatively configured to combine multiple caption streams 236a-236n and RSS streams 860 into a single multi-program caption stream 836 based on the program ID 410 identified in each packet 400, 600, or 1600 of the respective streams 236a-236n, 852, 856, and 860 and the location ID 1004 identified by the program manager 820 via the schedule database 242 as corresponding to the respective program ID 410. As previously discussed, the location ID 1004 in each program schedule record 1000 identifies the location where the respective program is to be or has been broadcast (as defined in the respective location record 1100 in the location reference database 828). The mixer and encrypter 824 is further operatively configured to combine each program information stream 852 and each firmware update stream 856 generated by the program manager 820 into the multi-program caption stream 836. Thus, the mixer and encrypter 824 may combine multiple caption streams 236a-236n for one or more of the caption caster systems 108 that the program manager 820 (or mixer and encrypter 824) identifies via the caption caster location database 826 has a corresponding location ID 1004, indicating that the one or more caption caster systems 108 is able to cast the multi-program or combined caption stream 836.

FIG. 17 depicts an exemplary structure of a multi-program or combined caption stream 836 as generated by the mixer and encrypter 824 of the caption caster controller 104 in accordance with the present invention. As shown in FIG. 17, the combined stream 836 for the one or more caption caster systems 108 includes the packets from each of the caption streams 236a-236n, each program information stream 852, each firmware update stream 856, and each RSS stream 860 (in the order received or generated by the program manager 820) with packets 400 or 600 having a program ID and location ID consistent with the one or more caption caster systems 108. Each multi-program or combined caption stream 836 may include a respective stream ID 506 to enable each portable receiver system 110 to differentiate between combined streams 836. As shown in FIG. 17, each packet in the multi-program caption stream 836 includes a program or packet type 418 to allow each portable receiver system 110 to identify the program type (e.g., a radio broadcast with or without embedded audio, a cinema program, or an RSS program) or packet type (e.g., program information packet or firmware update packet) for the packet and process the packet in accordance with the present invention. In the implementation shown in FIG. 17, the packets 1-m may correspond to a first stream 236a received from a first captioning computer system 102 providing captions in accordance with the present invention for two radio broadcast programs corresponding to program IDs #1 and #2. The packets n-w in the stream 836 of FIG. 17 may each correspond to program information packet 1500 in a program information stream 852 generated by the program manager 820 of the caption caster controller 104 to distribute program information 850 to one or more portable receiver systems 110 in accordance with the present invention. The packets x-z in the multi-program caption stream 836 may correspond to a second stream 236n received from a second captioning computer system 102 providing captions in accordance with the present invention for multiple radio programs corresponding to program IDs #3 and #n. In another example, packets x-z may correspond to RSS feed packets 1600 in an RSS stream 860 generated by the RSS aggregator 835.

The mixer and encrypter 824 may encrypt the stream 836 with a coded key to inhibit unauthorized access to the encrypted stream 836. In one implementation, each portable receiver system 110 operated by a registered subscriber has a decode key for decoding the encrypted stream 836. The mixer and encrypter 824 may encrypt each stream 836 using a commercially available encryption technique, such as the encryption technique available from Nexus, Entrust, Microsoft, or RSA Security.

In one implementation, a cinema caption stream 870 associated with a film or movie (e.g., a media file 232) may be provided directly from the source (such as a movie distributor) directly to the caption caster controller 104 rather than from a captioning computer system 102. Alternatively, the cinema caption stream 870 may be generated by the program manager 820 of the caption caster controller 104 from the program database 240 and the program content database 830. In this implementation, the program manager 820 may identify each program information record 900 in the program database 240 having a program type 902 corresponding to a cinema program and identifies each corresponding content ID 906. The program manager 820 then identifies each program content record 1300 in the program content database 830 having the same content ID 906. Next, the program manager 820 generates the cinema caption stream 870 to include one or more time sync packets 600 having respective captions 602 corresponding to the program content 1302 stored in each of the identified program content records 1300 associated with the respective program ID 410 of the cinema program. The cinema caption stream 870 may be generated consistent with the caption stream 236a or 236n such that the mixer and encrypter 824 may insert the packets corresponding to the cinema caption stream 870 into the multi-program caption stream 836 for distribution to the portable receiver systems 110 via one or more of the caption casting systems 108 in accordance with the present invention.

The caption stream distribution manager 816 may further include a listening pattern analyzer 840 module that is operatively configured to collect from the communication broker 822 and the subscriber manager 834 usage data from each portable receiver system 110 and correlates the date of the usage data with aggregate demographic usage data from each subscriber having an account in the subscriber database 838.

In addition, the caption stream distribution manager 816 may include an ad manager 842 module and an ad spots database 844 that includes one or more ad spots and associated schedule information (e.g., date and time to run the respective ad spot). The ad manager 842 is operatively configured to identify each ad spot in the ad spots database 844, generate one or more packets 400 or 600 to include the ad spot in lieu of the caption 404 or 602, and insert the identified ad spot packets 400 or 600 into a caption stream 236a or 236n or multi-program or combined caption stream 836 in accordance with the schedule information associated with the respective ad spot. The ad spots database 844 may be stored in secondary storage device 812 or memory 810 of the caption caster controller 104.

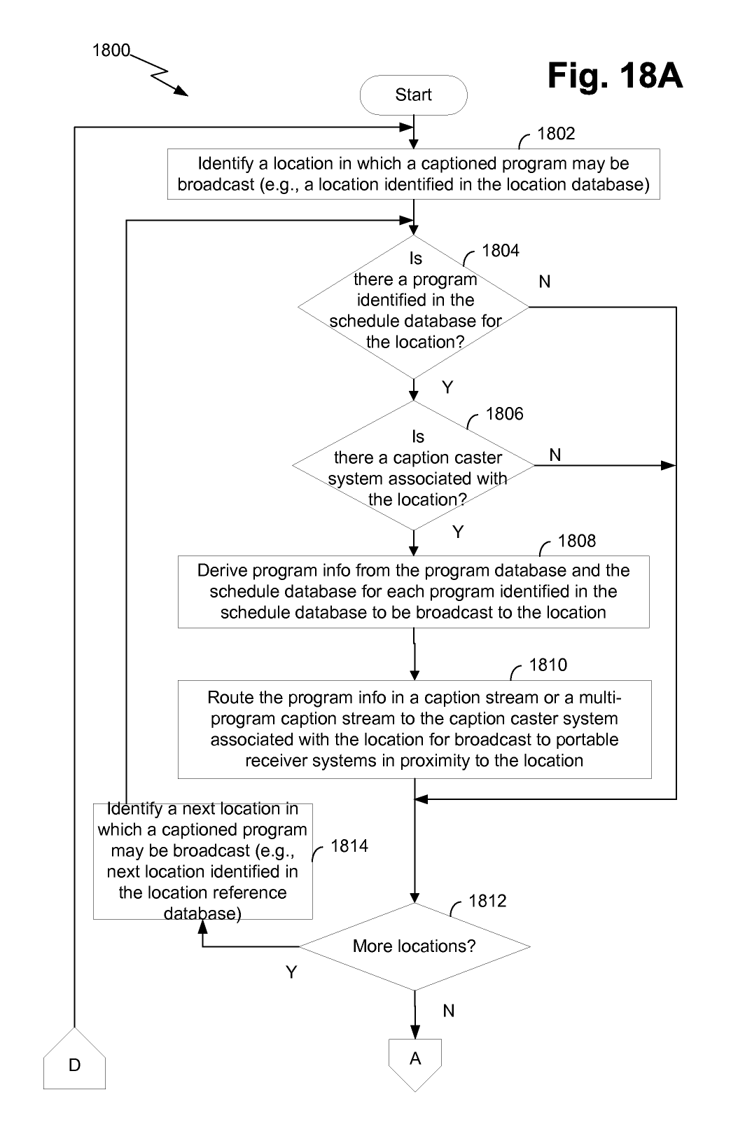

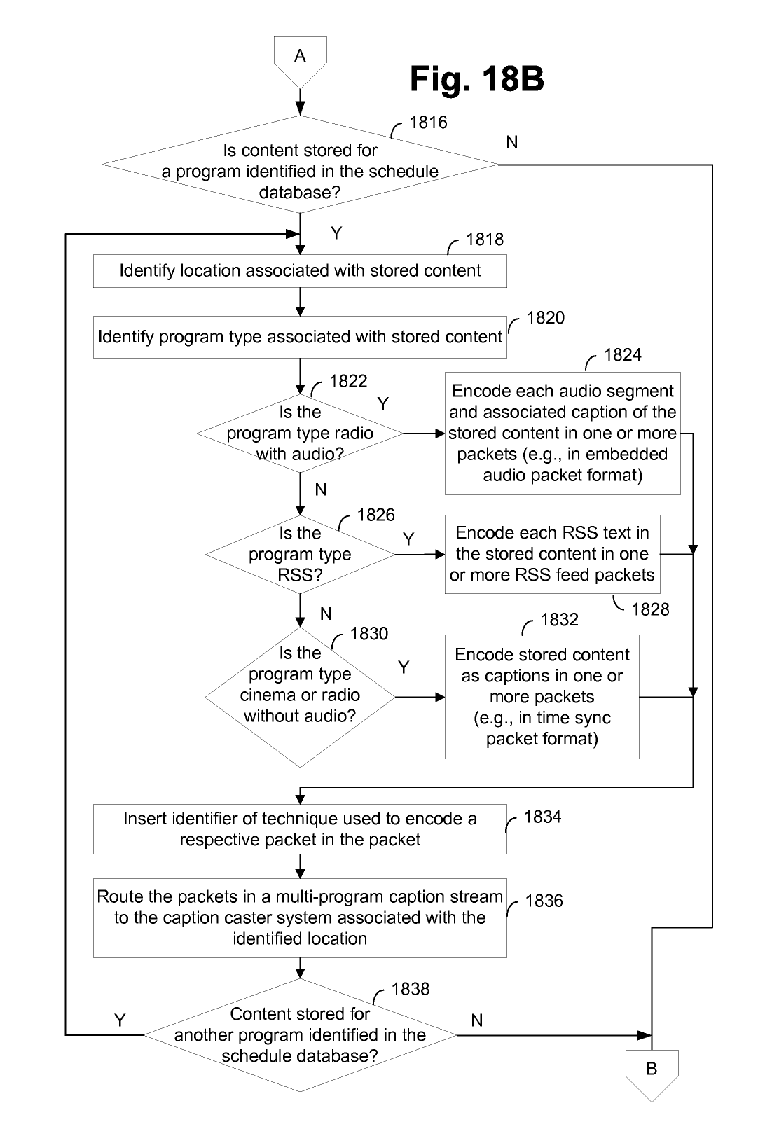

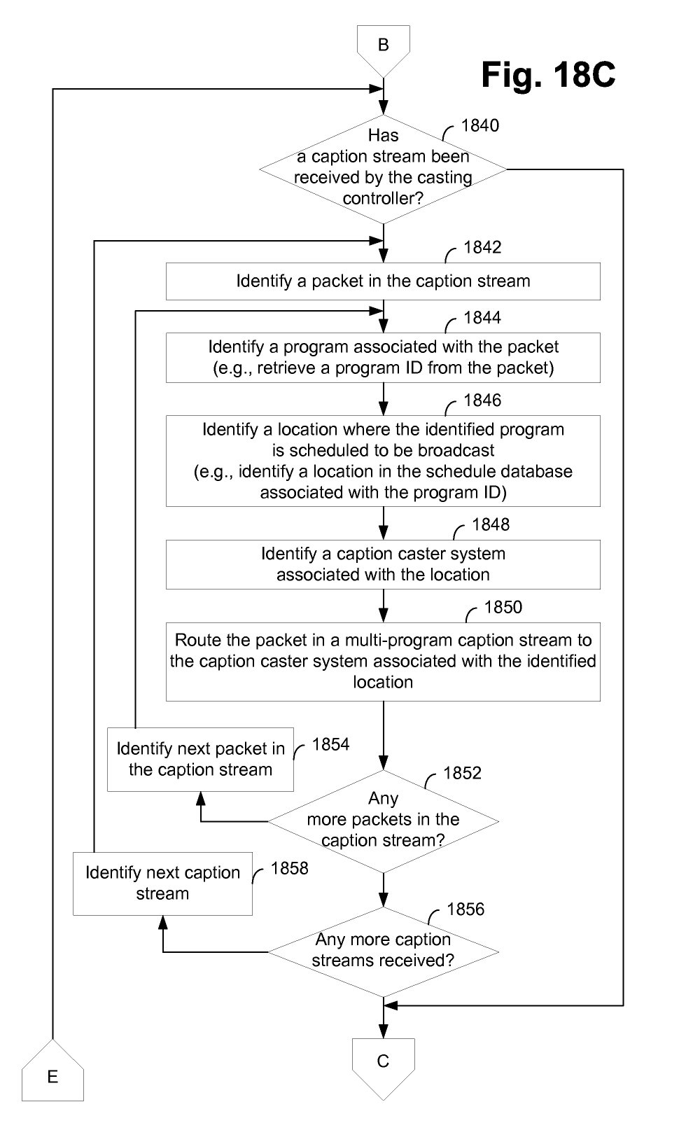

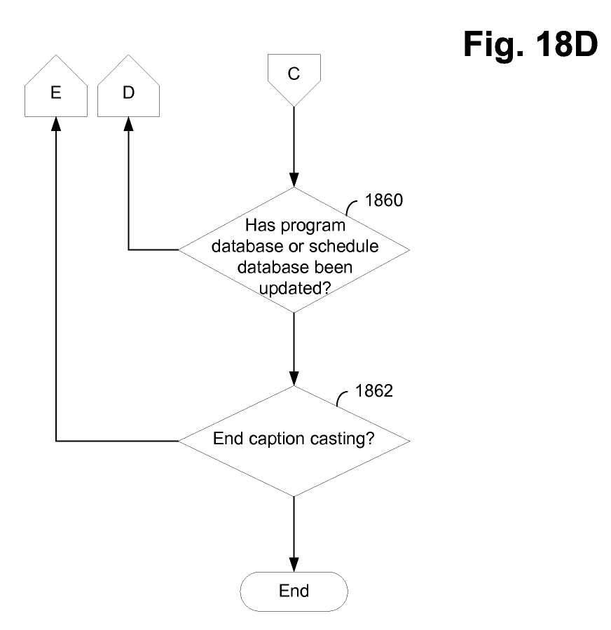

FIGS. 18A-D depict a flow diagram illustrating an exemplary process 1800 performed by the caption stream distribution manager 816 to identify a caption caster system 108 capable of casting a received caption stream 236a or 236n and to generate a multi-program or combined caption stream 836 from multiple caption streams 236a or 236n for the identified caption caster system 108. Initially, the caption stream distribution manager 816, via the program manager 820 module, identifies a location in which a captioned program may be broadcast (step 1802). In one implementation, the program manager 820 identifies the location by retrieving the first location ID 1004 in the first or one of the location records 1100 in the location reference database 828.

Next, the program manager 820 determines whether there is a program identified in the schedule database 242 for the location (step 1804). For example, the program manager 820 may use the identified location ID 1004 as an index into the schedule database 242 to identify a program schedule record 1000 that has the same location ID 1004. If a program schedule record 1000 having the same location ID 1004 is identified, the program manager 820 then identifies the program ID 410 in the same program schedule record 1000 to identify the program for the identified location.

If there is a program identified in the schedule database 242 for the identified location, the program manager 820 determines whether there is a caption caster system 108 associated with the identified location (step 1806). The program manager 820 may identify a caption caster system 108 associated with the identified location by using the location ID 1004 identified in step 1802 as an index for the caption caster location database 826 to locate a caption caster record 1200 having the same location ID 1004.

If a caption caster record 1200 having the same location ID 1004 is identified, the program manager 820 then derives program info 850 from the program database 240 and the schedule database 242 for each program identified (e.g., each program ID 410 in each program schedule record 1000) in the scheduled database to be broadcast to the location (step 1808). The program manager 820 then routes the program info 850 in a caption stream 236a or a multi-program caption stream 836 to the identified caption caster system 108 associated with the location for broadcast to portable receiver systems 110 in proximity to the location (step 1810). As discussed in further detail herein, the program manager 820 via the mixer and encrypter 824 may insert the derived program info 850 as one or more program info packets 1400 in the same multi-program caption stream 836 as other packets 400, 600, 1500, or 1600 to be routed to the identified caption caster system 108.

If there isn't a program identified in the schedule database 242 for the identified location or if there isn't a caption caster system 108 associated with the identified location or after routing the program info 850 in the multi-program caption stream 836 to the identified caption caster system 108, the program manager 820 determines whether there are more locations identified in the location reference database 828 in which a captioned program may be broadcast (step 1812). If there are more locations identified in the location reference database 828, the program manager 820 identifies a next location in which a captioned program may be broadcast (e.g., a next location ID 1004 identified in the location reference database 828) (step 1814) and continues processing at step 1804.

If there are no more locations identified in the location reference database 828, the program manager 820 determines whether content is stored for a program identified in the schedule database 242 (step 1816). In accordance with the present invention, the program content database 830 may include one or more content records 1300 associated with a cinema program or previously recorded radio program. For example, the program manager 820 may identify a program ID 410 in a program schedule record 1000 in the schedule database 242, retrieve the content ID 906 from a program information record 900 having the same scheduled program ID 410 in the program database 240, and use the content ID 906 as an index to the program content database 830 to identify program content 1302 in a program content record 1300 associated with the scheduled program ID 410. When the program ID 410 corresponds to a cinema program, the program content 1302 may include a plurality of captions (e.g., captions 602) associated with the cinema program or movie. When the program ID 410 corresponds to an RSS program, the program content 1302 may include a plurality of RSS encoded text (e.g., RSS encoded text 1602 in a packet 1600) associated with a previously recorded RSS program. When the program ID 410 corresponds to a radio program, the program content 1302 may include packets 400 with captions 404 associated with a previously broadcast radio program. The packets 400 for the radio program content 1302 also may include an audio segment or word embedded in association with a corresponding caption 404.

Continuing with FIG. 18B, if there isn't content stored for a program identified in the schedule database 242, the program manager 820 continues processing at step 1840. If it is determined that there is content stored for a program identified in the schedule database 242, the program manager 820 identifies the location associated with the stored content (step 1818). For example, after having identified in step 1816 a program information record 900 having a program ID 410 that is associated with a program content record 1300 having program content 1302, the program manager 820 uses the identified program ID 410 as an index into the program schedule database 242 to identify a program schedule record 1000 having a location ID 1004 reflecting a location where the program associated with the program ID 410 will or has been broadcast.

Next, the program manager 820 identifies the program type associated with the stored content (step 1820). In one implementation, the program manager 820 identifies the program type 902 in the program location record 900 associated with the identified program ID 410 having the associated stored content 1302.

After identifying the program type 902 associated with the stored content, the program manager 820 determines whether there the program type 902 corresponds to a radio program with audio (step 1822). As discussed in further detail herein, the program type 902 in each program information record 900 of the program database 240 may be one of a plurality of unique identifiers corresponding to at least one of the following: (1) a radio broadcast program that is captioned and distributed in packets 400 or 600 in accordance with the present invention, where each packet 400 or 600 has a caption 404 or 602 associated with an audio segment of the radio broadcast program; (2) a radio broadcast program that is captioned and distributed in packets 400 in accordance with the present invention, where each packet 400 includes an audio segment or word 402 of the radio program embedded in a respective packet 400 in association with a corresponding caption 404; (3) a cinema program or movie that is captioned and distributed in a time sync packet (such as the packet 600 format) in accordance with the present invention; and (4) an RSS program that is captioned and distributed in an RSS feed packet 1600 in accordance with the present invention. The program type 902 also may be set to identify a program info packet 1400 or a firmware update packet 1500.

If the identified program type 902 corresponds to a radio program with audio, the program manager 820 encodes each audio segment and associated caption in the stored content in one or more packets 400 (step 1824) and continues processing at step 1834.

If the identified program type 902 does not correspond to a radio program with audio, the program manager 820 determines whether the program type is an RSS program (step 1826). If the identified program type 902 corresponds to an RSS program, the program manager 820 encodes each RSS text 1602 in the stored content in one or more RSS feed packets 1600 (step 1828) and continues processing at step 1834.

If the identified program type 902 does not correspond to an RSS program, the program manager 820 determines whether the program type is a cinema program or a radio program without audio (step 1826). If the identified program type 902 corresponds to a cinema program or a radio program without audio, the program manager 820 encodes each caption 404 or 602 in the stored content in one or more packets 400 or 600 (step 1832) and continues processing at step 1834.

Next, the program manager 820 inserts an encoding technique identifier (e.g., first portion 416a of the version number 416) in each packet 400, 600, or 1600 to reflect the technique used to encode the respective packet or audio segment in the packet or caption in the packet (step 1834).

The program manager 820 then inserts the packets 400, 600, or 1600 in a multi-program caption stream 836 and routes the stream 836 to the caption caster system associated with the identified location or location ID 1004 (step 1836). In one implementation, the multi-program caption stream 836 may be the same stream 836 in which packets 1400 were inserted in step 1810.

The program manager 820 next determines whether there is content stored for another program identified in the schedule database 242 (step 1838). If there is content stored for another program identified in the schedule database 242, the program manager 820 continues processing at step 1818.

Turning to FIG. 18C, if there isn't content stored for another program identified in the schedule database 242, the program manager 820 determines whether a caption stream 236a or 236n has been received by the casting controller 104 from a captioning computer system 102 or other source (step 1840).

If a caption stream 236a or 236n has been received, the program manager 820 identifies a packet 400 or 600 in the caption stream 236a or 236n (step 1842). The program manager 820 then identifies a program associated with the identified packet 236a or 236n. For example, the program manager 820 may retrieve the program ID 410 from the identified packet 400 or 600 (step 1844).

Next, the program manager 820 identifies a location where the identified program is scheduled to be broadcast (step 1846) and then identifies a caption caster system 108 associated with the identified location (step 1848). In one implementation, the program manager 820 identifies the location by identifying a location ID 1004 in a program schedule record 1000 in the schedule database 242 associated with the identified program ID 410. The program manager 820 may identify a caption caster system 108 associated with the identified location by using the identified location ID 1004 as an index into the caption caster location database 826 to locate a caster ID 1202 associated with the caption caster system 108.

The program manager 820 then inserts the identified packet 400 or 600 in a multi-program caption stream 836 and routes the stream 836 to the caption caster system associated with the identified location (e.g., location ID 1004) (step 1850). In one implementation, the multi-program caption stream 836 may be the same stream 836 in which packets 400, 600, 1400 or 1600 were inserted in steps 1810 and 1836.

Next, the program manager 820 determines whether there are any more packets in the received caption stream 236a or 236n (step 1852). If there are more packets in the received caption stream 236a or 236n, the program manager 820 identifies the next packet in the received caption stream 236a or 236n (step 1854) and continues processing at step 1844.

If there are no more packets in the received caption stream 236a or 236n, the program manager 820 determines whether any more caption streams have been received (step 1856). If more caption streams 236a or 236n have been received, the program manager 820 identifies the next caption stream (e.g., 236n) to process (step 1858) and continues processing at step 1842.

If a caption stream 236a or 236n has not been received in step 1840 or no more caption streams 236a or 236n in step 1856, the program manager 820 determines whether the program database 240 or the schedule database 242 has been updated (step 1860). The program database 240 or the schedule database 242 may be updated by an administrator or other person with knowledge of the caster controller 104 while operating the caster controller 104 or via messages (not shown in the figures) sent via the network 106. The program database 240 may be updated to reflect new or cancelled programs. The schedule database 242 may be updated to reflect new or revised schedules for programs identified in the program database 240. If the program database 240 or the schedule database 242 has been updated, the program manager 820 continues processing at step 1802 so that program info 850 may be derived from the updated databases 240 and 242 for distribution to each portable receiver system 110 via a caption caster system 108 in accordance with the present invention.

If the program database 240 or the schedule database 242 has been updated, the program manager 820 determines whether to end caption casting (step 1862). An administrator operating the caster controller 104 may identify an end command to the program manager 820 using any standard input technique. If it is determined not to end caption casting, the program manager 820 continues processing at step 1840 to process more received caption streams 236a or 236n, otherwise the program manager 820 ends processing.

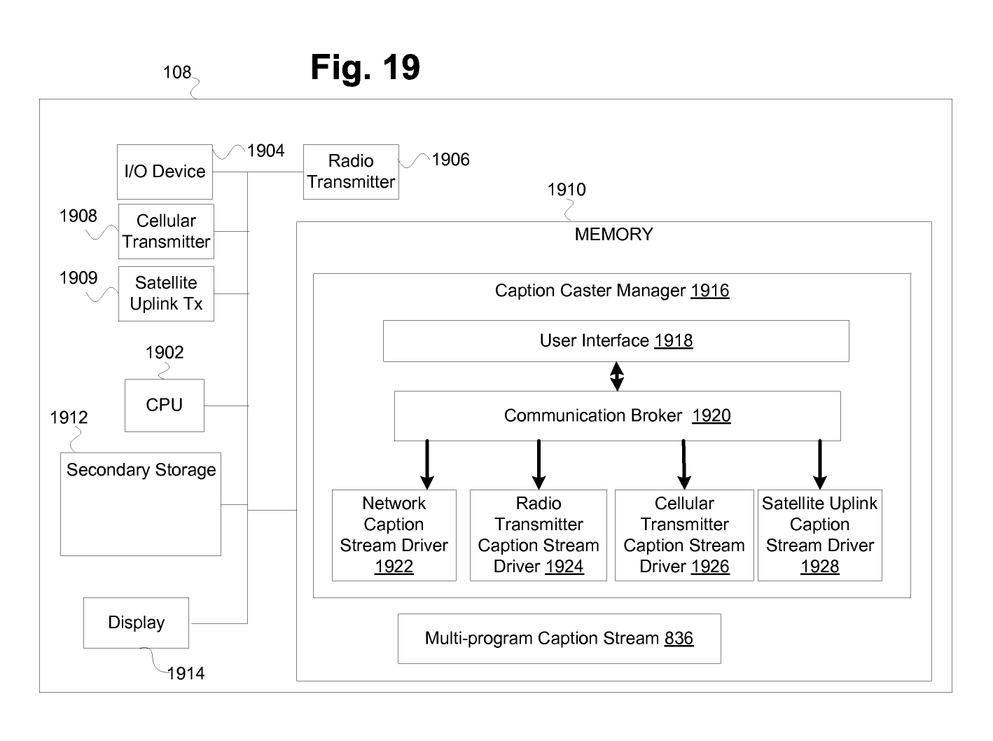

Turning to FIG. 19, a block diagram is shown depicting an exemplary embodiment of each caption casting system 108. Each caption casting system 108 may be any general-purpose computer system such as an IBM compatible, Apple, or other equivalent computer operatively configured as described herein. As shown in FIG. 19, each caption casting system 108 includes a central processing unit (CPU) 1902 and an input/output (I/O) device 1904 (e.g., for a network 106 connection). Each caption casting system 108 also may include a radio transmitter device 1906 or other I/O device (such as a cable modem) operatively configured to transmit a multi-program caption stream 836 to a corresponding radio broadcast station 122, a cellular transmitter device 1908 (e.g., a GSM, TDMA, or CDMA transmitter chip set) or other I/O device (such as a cable modem) operatively configured to transmit a multi-program caption stream 836 to a corresponding cellular network 124, and a satellite uplink transmitter device 1909 operatively configured to transmit a multi-program caption stream 836 to a corresponding satellite uplink 120. The devices 1904, 1906, 1908, and 1909 are collectively referenced as casting devices of the respective caption casting system 108. Each caption casting system 108 further includes a memory 1910, and a secondary storage device 1912. The caption caster controller 104 may also include a display 1914 and user input devices, such as a keyboard or a mouse (not shown in figures).

The memory 1910 stores a caption caster manager 1916 program that is called up by the CPU 1902 from memory 1910 as directed by the CPU 1902 to perform operations as described hereinbelow. As discussed in further detail below, the caption caster manager 1916 is operatively configured to cast or send each multi-program or combined caption stream 836 received from the caption caster controller to one or all of the casting devices of the respective caption casting system 108 so that the stream 836 is transmitted via a corresponding communication channel 112, 114, 116, or 118 (e.g., a cellular network 124 channel, a radio broadcast station 122 channel or sideband, a satellite uplink 120 channel, or network 106 channel) for broadcast to a portable receiver system 110.

As shown in FIG. 19, the caption caster manager 1916 includes a user interface 1918, a communication broker 1920 module operatively connected to the user interface 1918, a network caption stream driver 1922 operatively configured to control the transmission of a stream 836 over a network 106 channel via the I/O device 1904, a radio transmitter caption stream driver 1924 operatively configured to control the transmission of a stream 836 over a radio broadcast station 122 channel or sideband via the radio transmitter device 1906, a cellular transmitter caption stream driver 1926 operatively configured to control the transmission of a stream 836 over a cellular network 124 channel via the cellular transmitter device 1908, and a satellite uplink caption stream driver 1928 operatively configured to control the transmission of a stream 836 over a satellite uplink 120 channel via the satellite uplink transmitter device 1909. The communication broker 1918 is operatively configured to manage each communication between the caption caster controller 104 and the respective caption caster system 108, directing a received stream 836 to the captioning devices of the caption casting system 108 for casting to a portable receiver system 110.

FIG. 20 is a block diagram depicting an exemplary embodiment of each portable receiver system 110. As previously disclosed, the portable receiver system 110 includes a caption receiver device 126 and an eye piece 128 operatively connected to the caption receiver device 126 to enable a user 130 to selectively view a caption stream 236a or 236n, which may be embedded in a multi-program or combined caption stream 836. As discussed in further detail below, the caption receiver device 126 is operatively configured to operate in one of a plurality of user-selectable modes, including a radio mode, a cinema mode, and an RSS mode. When operating in the radio mode, the caption receiver device 126 is operatively configured to receive a multi-program or combined caption stream 836, decode it into separate caption streams 236a or 236n, and save the caption streams 236a or 236n for playback. The caption receiver device 126 also is operatively configured to identify a caption stream 236a or 236n associated with a user selected radio station and extract audio segments and associated captions from the identified caption stream for viewing on the eye piece 128 in accordance with the present invention.

When in RSS mode, the caption receiver device 126 is operatively configured to identify a user selected RSS stream 860 within the combined stream 836, extract the RSS captions or data from the RSS stream 860, and send the RSS captions or data to eye piece 126.

When in cinema mode, the caption receiver device 126 extracts a caption stream 236a or 236n associated with a movie source from the combined stream 836 and stores the extracted caption streams for playback on the eye piece when a user enters a corresponding sync code into the caption receiver device 126. A respective sync code may be obtained by the user from the movie theater exhibiting the movie.

The eye piece 128 may be an SV-6 Video Viewer commercially available from MicroOptical Corp., a TAC-EYE Viewer commercially available from Icuity, or other portable display device that is capable of projecting a supplied caption in the field-of-view of the user. The eye piece 128 also may have a viewer controller (not shown in the figures) for user selectable adjusting of the brightness, contrast and frame rate of caption streams 236a or 236n provided by the caption receiver device 126 in accordance with the present invention.

As shown in FIG. 20, each caption receiver device 126 includes a central processing unit (CPU) 2002 and one or more of the following caption receiving devices:

a wireless I/O device 2003, such as a wi-fi adapter, operatively configured to wirelessly connect the caption receiver device 126 to the network 106 to receive a stream 836 from a caption casting system 108;

a radio receiver device 2004 (which may be a standard analog RF receiver or a digital RF receiver such as a FMeXtra™ receiver commercially available from Digital Radio Express) operatively configured to wirelessly connect the caption receiver device 126 to the radio broadcast station 122 communication channel 114 to receive a stream 836 from a caption casting system 108;

a cellular phone receiver device 2006 operatively configured to wirelessly connect the caption receiver device 126 to the cellular network 124 communication channel 112 to receive a stream 836 from a caption casting system 108; and

a satellite receiver device 2007 operatively configured to wirelessly connect the caption receiver device 126 to the satellite 120 communication channel 116 to receive a stream 836 from a caption casting system 108.

Each caption receiver device 126 also includes a display controller 2008, such as a digital signal processor. The display controller 2008 is operatively configured to convert a caption or captions (extracted from a stream 236a, 236n, or 836n received by the caption receiver device) into a video image using a standard protocol such as a NTSC/PAL video output standard for display on the eye piece 128.

Each caption receiver device 126 also includes a power supply such as a battery (not shown in figures) operatively connected to other components (e.g., CPU 2002, caption receiving devices 2003, 2004, 2006, and 2007, and display controller 2008) of the caption receiver device 126 to provide applicable power to the other components.

Each caption receiver device 126 further includes a memory 2010, which may be a removable, reprogrammable memory, such as a non-volatile flash memory card for storing programs executed by the CPU 2002. Each caption receiver device 126 also may include a secondary storage device 2012, which also may be a removable memory device, such as a flash memory card or writable compact disk for storing received caption streams in accordance with the present invention.

In addition, each caption receiver device 126 may include an I/O bus connector 2011, an audio output adapter 2013, an annunciator 2014, and a keypad 2015 (or other input device such as a selection wheel or scroll bar switch). The I/O bus connector 2011 may be a USB connector or other serial bus connector, which may be connected to a user's computer (not shown in figures) to upload a program or file into memory 2010 or secondary storage 2012. The audio output adapter 2013 may be a speaker or a headphone amplifier and connector operatively configured to audibly output an audio segment associated with a caption extracted from a received caption stream. The annunciator device 2014 is operatively configured to vibrate when activated to announce emergency warnings to the portable receiver system 110. This annunciator 2014 also flashes colors on the eye piece along with emergency notification data. The keypad 2015 functions as a user input device and may include a standard set of QUERY keys as well as dedicated keys for activating caption store functions or prompting and controlling menu selections (not shown in figures). Keypad 2015 activated menu selections may include a respective selection for prompting the caption receiver device 126 to enter the radio mode, the cinema mode, or the RSS mode. In addition, keypad 2015 activated menu selections may include an activation key for selecting a radio station 122 communication channel 114 or other communication channel 112, 116, or 118 to view captions 404 or 406 on the eye piece 128 extracted from a stream 236a, 236n, or 238 associated with a broadcast program audio stream 230.

The memory 2010 stores a caption receiver controller 2016 program that is called up by the CPU 2002 from memory 2010 as directed by the CPU 2002 to perform operations as described hereinbelow. The caption receiver controller 2016 may include: a user interface 2018 (which may include keypad 2015 activated menu selections), a communication broker and device driver 2020; and a program recorder 2022. The communication broker and device driver 2020 operates as a communication gateway and controller for the caption stream receiving devices 2003, 2004, 2006, and 2007 and for the other devices of the caption receiver 126, including the display controller 2008, the I/O bus connector 2011, the audio output adapter 2013 and the annunciator 2014. The communication broker and device driver 2020 is further operatively configured to decrypt received streams 836 based on a decrypt or decode key in accordance with a standard public and private key digital signature algorithm.

The program recorder 2022 is operatively configured to record caption streams 236a-236n in memory 110 or secondary storage 112 that are received via communication channel 112, 114, 116, or 118. In addition, the program recorder 2022 also is operatively configured to record user's (or listener's) usage patterns and send the patterns to the caption caster controller 104 for comparison with users of other portable receiver systems 110.

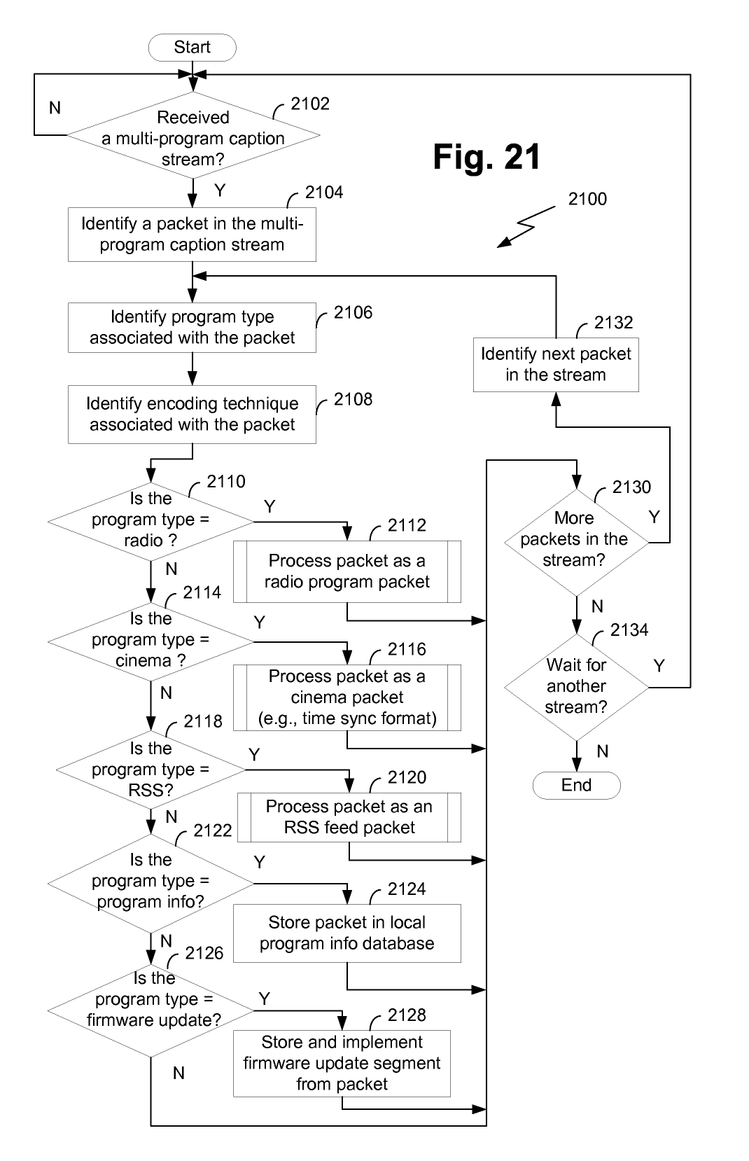

FIG. 21 depicts a flow diagram illustrating an exemplary process 2100 performed by a respective portable receiver system 110 to decode a received multi-program or combined caption stream 836 in accordance with the present invention. Initially, the caption receiver controller 2016 of the respective portable receiver system 110 determines whether a multi-program caption stream has been received (step 2102). The caption receiver controller 2016 may monitor each caption stream receiving device 2003, 2004, 2006, and 2007 or one of the employed caption stream receiving devices 2003, 2004, 2006, and 2007 in the respective portable receiver system 110 for a multi-program caption stream 836.

If a multi-program caption stream is not received, the caption receiver controller 2016 may continue to wait for a multi-program caption stream 836, for example, while processing other user input. If a multi-program caption stream is received, the caption receiver controller 2016 identifies a current packet 2023 in the multi-program caption stream 836 (step 2104). The current packet 2023 is consistent with one of the packet formats 400, 600, 1400, 1500, and 1600.

Next, the caption receiver controller 2016 identifies the program type 814 associated with the packet 2023 (step 2106) and identifies the encoding technique associated with the packet 2023 (step 2108) as reflected by the first portion 416a of the version number 416 in the packet 2023.

The caption receiver controller 2016 then determines whether the program type 814 of the packet 2023 corresponds to a radio program (step 2110). If the program type 814 corresponds to a radio program, the caption receiver controller 2016 processes the packet 2023 as a radio program packet (step 2112) as discussed in further detail below. In one implementation, the caption receiver controller 2016 may employ a look up table (not shown in the figures) using the program type 814 as an index into its table to identify the program associated with the program type 814 in the packet 2023 currently being processed. Accordingly, the caption receiver controller 2016 is able to effectively perform steps 2110, 2114, 2118, 2122, and 2126 simultaneously.

If the program type 814 does not correspond to a radio program, the caption receiver controller 2016 determines whether the program type 814 of the packet 2023 corresponds to a cinema program (step 2114). If the program type 814 corresponds to a cinema program, the caption receiver controller 2016 processes the packet as a cinema packet (e.g., time sync packet format 600) (step 2116).

If the program type 814 does not correspond to a cinema program, the caption receiver controller 2016 determines whether the program type 814 of the packet 2023 corresponds to a RSS program (step 2118). If the program type 814 corresponds to an RSS program, the caption receiver controller 2016 processes the packet as an RSS feed packet 1600 (step 2120).

If the program type 814 does not correspond to an RSS program, the caption receiver controller 2016 determines whether the program type 814 of the packet 2023 corresponds to program info 850 (step 2122). If the program type 814 corresponds to program info 850, the caption receiver controller 2016 stores the packet 2023 as a record in the local program info database 2024 (step 2124).

If the program type 814 does not correspond to program info, the caption receiver controller 2016 determines whether the program type 814 of the packet 2023 corresponds to a receiver firmware update 854 (step 2126). If the program type 814 corresponds to a receiver firmware update 854, the caption receiver controller 2016 stores and implements the firmware update segment 1502 from the packet 2023 (step 2128).

If the program type 814 does not correspond to a radio program, a cinema program, an RSS program, program info, or a receiver firmware update, the caption receiver controller 2016 determines whether there are more packets (e.g., 400, 600, 1400, 1500, or 1600) in the received multi-program caption stream 836 (step 2130). If there are more packets in the received multi-program caption stream 836, the caption receiver controller 2016 identifies the next packet in the stream (step 2132) as the current packet 2023 and continues processing at step 2106.

If there are no more packets in the received multi-program caption stream 836, the caption receiver controller 2016 determines whether to wait for another stream (step 2134). In one implementation, the caption receiver controller 2016 may continue to monitor each caption stream receiving device 2003, 2004, 2006, and 2007 or one of the employed caption stream receiving devices 2003, 2004, 2006, and 2007 in the respective portable receiver system 110 for another multi-program caption stream 836 while the portable receiver system 110 remains powered on. Alternatively, a user may direct the caption receiver controller 2016 to end waiting for another stream by selecting a dedicated keypad 2015 button or menu selection. One skilled in the art will appreciate that the CPU 2002 of each portable receiver system 110 is able to perform other tasks or application threads substantially in parallel with waiting for another multi-program caption stream 836. If the caption receiver controller 2016 determines that it is to wait for another stream, the caption receiver controller 2016 continues processing at step 2102 or otherwise ends processing.

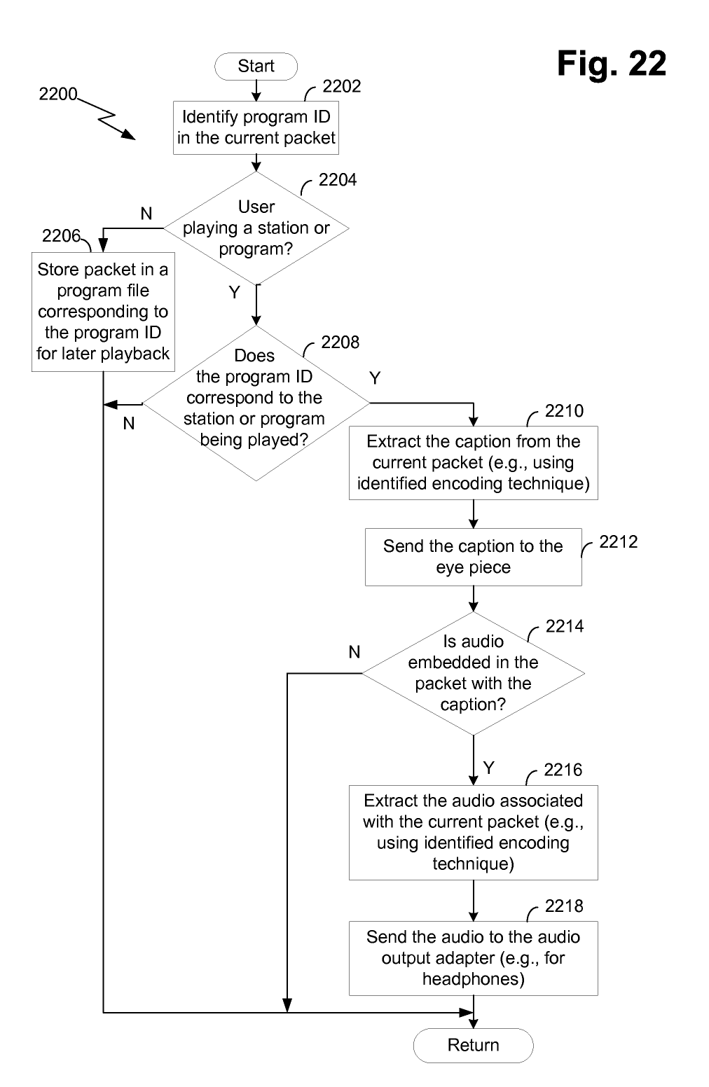

FIG. 22 depicts a flow diagram illustrating an exemplary process 2200 performed by the caption receiver controller 2016 of the respective portable receiver system 110 when the caption receiver controller 2016 determines that the received multi-program caption stream 836 includes a current packet 2023 having a program type 418 corresponding to a radio program with or without embedded audio. The caption receiver controller 2016 is able to recognize the current packet 2023 as corresponding to a radio program transmitted in a packet 400 format with or without embedded based on the program type 418 associated with the current packet 2023. Initially, the caption receiver controller 2016 identifies a program ID 410 in the current packet 2023 (step 2202).

Next, the caption receiver controller 2016 determines whether the user is playing or has selected a radio station or radio program (step 2204). In one implementation, the user may identify a radio station or radio program to play to the caption receiver controller 2016 by selecting a corresponding keypad 2015 activated menu selection or scroll button (not shown in figures).

If the user is not playing or has not selected a radio station or program, the caption receiver controller 2016 may store the current packet 2023 in a program file 2026a or 2026n corresponding to the program ID 410 in the current packet 2023 for later user selectable playback on the eye-piece 128 before returning to step 2130 of process 2100 to continue processing or ending processing (step 2206). In one implementation, when a program file 2026a or 2026n is created by or provided to the caption receiver controller 2016, the respective program file 2026a or 2026n includes a program ID 410 corresponding to a program identified a record (e.g., program info packet 1400) in the program info database 2024 so that the caption receiver controller 2016 may associate a current packet 2023 with a respective program file 2026a or 2026n based on the program ID 410 in the current packet. Alternatively, the caption receiver controller 2016 may associate a program ID 410 in a packet (e.g., a packet 400, 600, or 1600) previously stored in a program file 2026a or 2026n in accordance with the present invention as the program ID corresponding to the program file 2026a or 2026n.

If the user is playing or has selected a radio station or program, the caption receiver controller 2016 determines whether the program ID 410 in the current packet 2023 corresponds to the radio station or program being played (step 2208). In one implementation, once the user identifies a radio station or program to play to the caption receiver controller 2016 (e.g., by selecting a corresponding keypad 2015 activated menu selection or scroll button), the caption receiver controller 2016 is able to associate a program ID 410 in a record or program info packet 1400 in the program info database 2024 with the user identified radio station or program.

If the program ID 410 in the current packet 2023 corresponds to the radio station or program being played, the caption receiver controller 2016 extracts the caption (e.g., caption 404 in packet 400 or caption 602 in packet 600) from the current packet 2023 (step 2210) using the encoding technique associated with the current packet 2023 and sends the caption to the eye piece (step 2212) via the display controller 2008.

Next or currently with step 2210, the caption receiver controller 2016 determines whether there is an audio segment embedded in the current packet 2023 with the caption (step 2214). In one implementation, the caption receiver controller 2016 is able to determine that an audio segment is embedded with the caption in the current packet 2023 based on the program or packet type 418 in the current packet.

If an audio segment (e.g., 402) associated with the caption (e.g., 404) is embedded in the caption stream 236a, the caption receiver controller 2016 extracts the audio segment associated with the caption from the current packet 2023 (step 2216) using the encoding technique associated with the current packet 2023. The caption receiver controller 2016 then sends the audio segment to the audio output adapter (e.g., for output to user headphones) (step 2218).

If the program ID 410 in the current packet 2023 does not correspond to the radio station or program being played or if an audio segment is not embedded in the current packet 2023 or after sending the audio segment (e.g., 402) to the audio output adapter in step 2218, the caption receiver controller 2016 returns to step 2130 of process 2100 to continue processing or end processing.

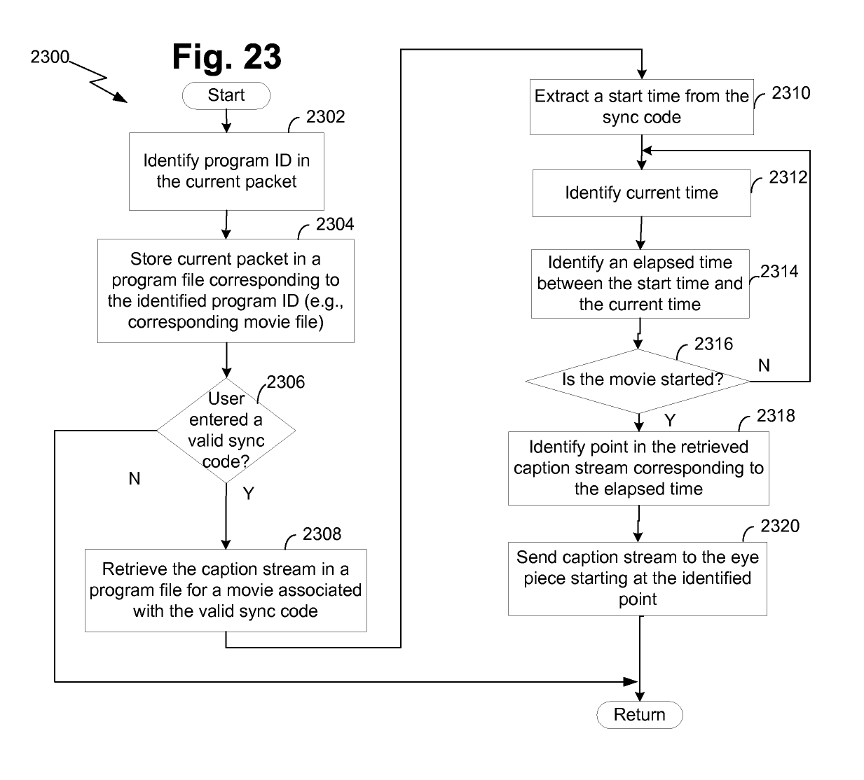

FIG. 23 depicts a flow diagram illustrating another exemplary process 2300 performed by the receiver controller 2016 of the respective portable receiver system 110 when the caption receiver controller 2016 determines that the received multi-program caption stream 836 includes a current packet 2023 having a program type 418 corresponding to a cinema program. The caption receiver controller 2016 is able to recognize the current packet 2023 as corresponding to a cinema program transmitted in a packet 600 format based on the program type 418 associated with the current packet 2023. Initially, the caption receiver controller 2016 identifies a program ID 410 in the current packet 2023 (step 2302) before storing the current packet 2023 in a program file (e.g., file 2026a) corresponding to the program ID 410 (step 2304) of the cinema program.

The caption receiver controller 2016 then determines whether the user entered a valid sync code (step 2306) associated with a movie or cinema program. In one implementation, the caption receiver controller 2016 receives a message 2028 via wireless I/O device 2003 from the caption caster controller 104, movie distributor, or other source of movie content, where the message includes a valid sync code 2032 and corresponding movie identifier 2030 (e.g., corresponding to a program ID 410) that the caption receiver controller 2016 is able to associate with the program ID 410 of the current packet 2023 being processed. Each valid sync code 2032 includes a start time for the respective movie to be viewed at a theatre or other location.

If the user did enter a valid sync code, the caption receiver controller 2016 retrieves the caption stream in a program file (e.g., previously stored packets 600 associated with a cinema program file 2026a) for the movie or cinema program associated with the valid sync code 2032 (step 2308) and extracts a start time from the sync code (step 2310). In one implementation, the program file need not be the program file corresponding to the identified program ID 410 in the current packet 2023. The caption receiver controller 2016 then identifies a current time (step 2312) via an internal clock (not shown in the figures) of the portable receiver system 110 or in response to a request for a time message (not shown in the figures) sent by the caption receiver controller 2016 via the wireless I/O device 2003 to another computer or server on the network 106. The caption receiver controller 2016 next identifies or calculates an elapsed time between the start time and the current time (step 2314). The caption receiver controller 2016 subsequently determines whether the movie or cinema program has started (step 2316) based on the elapsed time. For example, if the elapsed time is negative or the current time is earlier than the start time, the caption receiver controller 2016 determines that the movie or cinema program has not started and continues processing at step 2312 while waiting for the current time to match the start time (e.g., elapsed time equals zero). If the elapsed time is zero or positive (e.g., current time is later than the start time), the caption receiver controller 2016 identifies the point in the retrieved caption stream in the program file 2026a corresponding to the elapsed time (step 2318) and sends the retrieved caption stream to the eye piece 128 of the respective portable receiver system 110 starting at the identified point (step 2320).

If the user did not enter a valid sync code or after sending the caption stream associated with the movie or cinema program to the eye piece 128, the caption receiver controller 2016 returns to step 2130 of process 2100 to continue processing or ends processing.

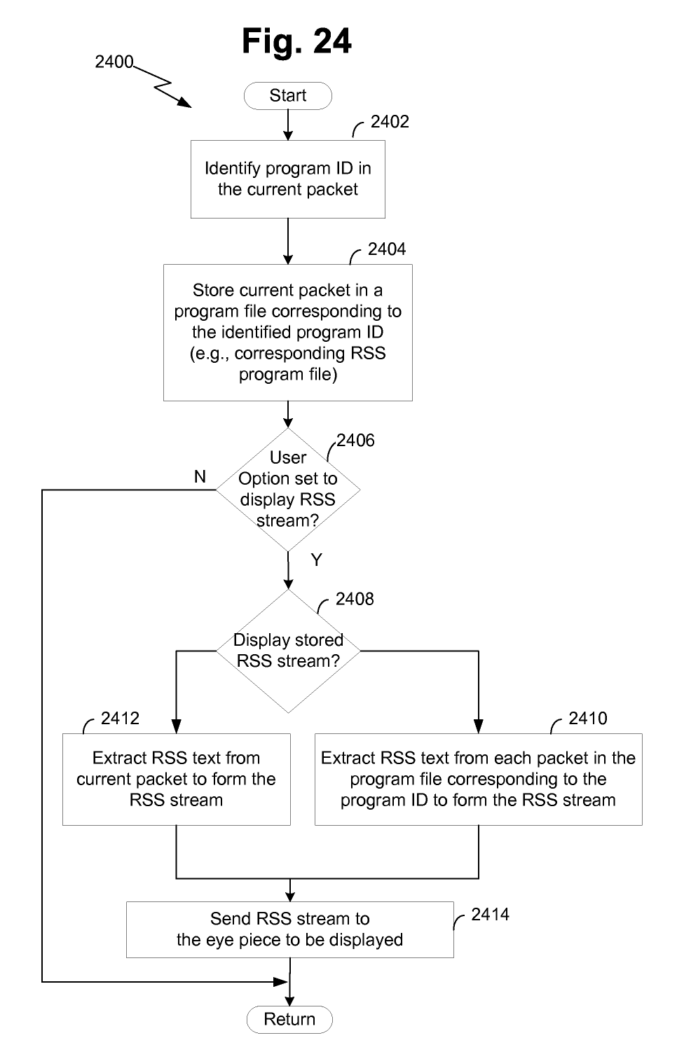

FIG. 24 depicts a flow diagram illustrating another exemplary process 2400 performed by the receiver controller 2016 of the respective portable receiver system 110 when the receiver controller 2016 determines that the received multi-program caption stream 836 includes a current packet 2023 having a program type 418 corresponding to an RSS program. As previously noted, the caption receiver controller 2016 is able to recognize the current packet 2023 as corresponding to an RSS feed packet 1600 based on the program type 418 associated with the current packet 2023. In one implementation, the caption receiver controller 2016 initially identifies a program ID 410 in the current packet 2023 (step 2402) before storing the current packet 2023 in a program file (e.g., file 2026a) corresponding to the program ID 410 (step 2404). Alternatively, the caption receiver controller 2016 may be operatively configured to omit performing step 2404 and store each packet 2023 corresponding to an RSS feed packet 1600 in the same program file 2026a dedicated to RSS feed packets 1600.

Next, the caption receiver controller 2016 determines whether a user option (e.g., keypad 2015 activated menu selection for an RSS source) has been set to display an RSS stream (step 2406). If a user option has been set to display an RSS stream, the caption receiver controller 2016 then determines whether to display an RSS stream stored in the program file 2026a corresponding to the identified program ID 410 of the current packet 2023 or dedicated to RSS feed packets 1600 (step 2408). A user operating the portable receiver system 110 may identify that the RSS stream stored in the program file 2026a (e.g., an RSS program previously recorded on the portable receiver system 110 in accordance with the present invention) by, for example, a keypad 2015 activated menu selection. If the RSS stream stored in the program file 2026a is to be displayed, the caption receiver controller 2016 extracts each RSS text 1602 (which may be decoded based on the encoding technique identified in step 2106 as being associated with the current packet 2023) from each packet 1600 in the program file 2026a corresponding to the identified program ID 410 of the current packet 2023 or dedicated to RSS feed packets 1600 in order to form the RSS stream to be displayed (step 2410). Alternatively, if the RSS stream stored in the program file 2026a is not to be displayed, the caption receiver controller 2016 recognizes that the user has opted to view current RSS text and extracts the RSS text 1602 from the current packet 2023 to form the RSS stream (step 2412). The caption receiver controller 2016 then sends the RSS stream to the eye piece 128 of the user's portable receiver system 110 for display (step 2414) before returning to step 2130 of process 2100 to continue processing.

If a user option has not been set to display an RSS stream or after sending the RSS stream to the eye piece 128, the caption receiver controller 2016 returns to step 2130 of process 2100 to continue processing or ends processing.

The foregoing description of an implementation of the invention has been presented for purposes of illustration and description. The description is not exhaustive and does not limit the invention to the precise form disclosed. Modifications and variations are possible in light of the above teachings or may be acquired from practicing the invention. For example, the described implementation includes software (e.g., caption generator 216, caption stream distribution manager 816, and caption receiver controller 1516) but the present implementation may be implemented as a combination of hardware and software or hardware alone. Further, the illustrative processing steps performed by the caption generator 216, caption stream distribution manager 816, the caption receiver controller 1516, or other disclosed modules can be executed in an order different than described above, and additional processing steps can be incorporated. The invention may be implemented with both object-oriented and non-object-oriented programming systems. The scope of the invention is defined by the claims and their equivalents.

In addition, although aspects of one implementation of the invention are depicted as being stored in memory, one skilled in the art will appreciate that all or part of systems and methods consistent with the present invention may be stored on or read from other computer-readable media, such as secondary storage devices, like hard disks, floppy disks, and CD-ROM; a carrier wave received from a network such as the Internet; or other forms of ROM or RAM either currently known or later developed. Further, although specific components of the captioning and casting system 100 have been described, one skilled in the art will appreciate that a captioning and casting system suitable for use with methods, systems, and articles of manufacture consistent with the present invention may contain additional or different components.

When introducing elements of the present invention or the preferred embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

While various embodiments of the present invention have been described, it will be apparent to those of skill in the art that many more embodiments and implementations are possible that are within the scope of this invention. Accordingly, the present invention is not to be restricted except in light of the attached claims and their equivalents.

What is claimed is:

1. A captioning and casting system, comprising:
a captioning computer system,
a caption caster controller operatively connected to the captioning computer system; and
a caption caster system operatively configured to communicate with the caption caster controller;
wherein the captioning computer system includes:
an audio input device operatively configured to receive an audio stream corresponding to one of a plurality of radio programs broadcast by one or more radio stations, each of the radio programs being assigned a respective one of a plurality of program identifiers;
a first memory device that has a caption generator program that identifies one or more segments of the audio stream, identifies a caption corresponding to each respective segment, embeds each identified caption in a caption stream in association with the program identifier assigned to the one radio program; and transmits the caption stream to the caption caster controller; and
a first processor to run the caption generator program,
wherein the caption caster controller is operatively configured to retrieve the program identifier embedded in the caption stream, determine whether the retrieved program identifier is associated with a location of the caption caster system, and distribute the caption stream in a multi-program stream to the caption caster system in response to determining the retrieved program identifier is associated with the caption caster system location.

2. A captioning and casting system of claim 1, further comprising:
a portable receiver system having an eye piece and a caption receiver device operatively connected to the eye piece, the caption receiver device being operatively configured to receive the multi-program caption stream from the caption caster system and to selectively display on the eye piece at least one caption embedded in the multi-program caption stream.

3. A captioning and casting system of claim 2, wherein the caption stream is one of a plurality of caption streams transmitted by the captioning computer system to the caption caster controller and each caption stream corresponds to a different radio program.

4. A captioning and casting system of claim 2, wherein the caption generator program of the captioning computer system is operatively configured to embed each identified caption in a caption stream by encoding each identified caption in a respective one of a plurality of packets using one of a plurality of encoding techniques, providing within each packet an encoding identifier corresponding to the one encoding technique used to encode the caption in the respective packet, providing within each packet the program identifier corresponding to the one radio program, and embedding each of the packets in the caption stream.

5. A captioning and casting system of claim 4, wherein the caption caster controller is operatively configured to retrieve the program identifier embedded in each packet of the caption stream, determine whether the retrieved program identifier from each packet is associated with the location of the caption caster system, and distribute in a multi-program stream to the caption caster system each packet of the caption stream in which the retrieved program identifier is associated with the caption caster system location.

6. A captioning and casting system of claim 5, wherein the caption receiver device is operatively configured to decode the caption in each packet in the multi-program caption stream based on the encoding technique provided in the respective packet.

7. A captioning and casting system of claim 1, wherein the caption caster controller includes:
a secondary storage having a schedule database and a caption caster location database, the schedule database having one or more program schedule records each of which has one of the plurality of program identifiers and an associated one of a plurality of location identifiers, the location identifier in each program schedule record reflecting the location where the program corresponding to the program identifier in the respective program schedule record is scheduled to be broadcast, the caption caster location database having one or more caption caster records each of which has one of a plurality of caption caster system identifiers and one of the plurality of location identifiers;
a second memory device that has a caption stream distribution manager program that identifies a first of the program schedule records in the schedule database, identifies a first caption caster system identifier based on the location identifier in the first program schedule record, derives program information from each program schedule record in the schedule database having the same location identifier as the first schedule record; and routes the program information in one or more program information packets in the multi-program caption stream to the caption caster system associated with the first caption caster system identifier; and
a second processor to run the caption stream distribution manager program.

8. A captioning and casting system of claim 1, wherein the caption caster controller includes:
a secondary storage including a program database, a schedule database, a program content database, and a caption caster location database,
the program content database having a plurality of program content records, each program content record having program content associated with one of a cinema program, an RSS program, or the plurality of radio programs, each of the cinema program, the RSS program, and the radio programs being assigned one of the plurality of program identifiers,
the program database having one or more program information records each of which has one of the program identifiers, one of a plurality of program types, and a content ID reflecting whether the program identifier is associated with one of the program content records, each of the plurality of program types corresponding to a respective one of the cinema program, the RSS program, or one of the plurality of radio programs,
the schedule database having one or more program schedule records each of which has one of the plurality of program identifiers and an associated one of a plurality of location identifiers, the location identifier in each program schedule record reflecting the location where the program corresponding to the program identifier in the respective program schedule record is scheduled to be broadcast,
the caption caster location database having one or more caption caster records each of which has one of a plurality of caption caster system identifiers and one of the plurality of location identifiers;
a second memory device that has a caption stream distribution manager program that identifies a first of the program content records associated with the program identifier in a first of the program schedule records, identifies the location identifier associated with the first content record based on the program identifier in the first program schedule record, identifies a first caption caster system identifier based on the location identifier in the first program schedule record, identifies the program type associated with the program identifier in the first program schedule record, encodes the program content of the first program content record in one or more packets based on the identified program type, and routes the one or more packets in the multi-program caption stream to the caption caster system associated with the first caption caster system identifier; and
a second processor to run the caption stream distribution manager program.

9. A captioning and casting system of claim 8, wherein each program content associated with the cinema program has a plurality of captions corresponding to the cinema program and, when the identified program type corresponds to the cinema program, the caption stream distribution manager program encodes each caption in the program content of the first program content record in a respective one of the one or more packets in accordance with a time sync packet format.

10. A captioning and casting system of claim 8, wherein each program content associated with the RSS program has a plurality of RSS text and, when the identified program type corresponds to the RSS program, the caption stream distribution manager program encodes each RSS text in the program content of the first program content record in a respective one of the one or more RSS feed packets.

11. A captioning and casting system of claim 8, wherein each program content associated with each radio program has a plurality of audio segments and a plurality of captions each of which corresponds to a respective one of the audio segments and, when the identified program type corresponds to one of the radio programs, the caption stream distribution manager program encodes each audio segment and each corresponding caption in the program content of the first program content record in a respective one of the one or more packets.

12. A portable receiver system for use in a captioning and casting system, comprising:
an eye piece; and
a caption receiver device operatively connected to the eye piece, the caption receiver including:
a user input device;
a caption receiving device operatively configured to receive a multi-program caption stream, the caption receiving device corresponding to one of a wireless I/O device, a radio receiver device, a cellular receiver device, or a satellite receiver device, the wireless I/O device being operatively configured to wirelessly connect the caption receiver device to a network to receive the multi-program caption stream from a casting source;
a first memory device that has a caption receiver controller program that identifies a packet in the multi-program caption, identifies a program type associated with the packet, identifies an encoding technique associated with the packet, identifies a program ID in the packet, determines whether the program type corresponds to a radio program type, and when it is determined that the program type corresponds to a radio program type and the program ID corresponds to a radio program selected for play on the portable receiver system via the user input device, the caption receiver controller extracts a caption from the packet using the identified encoding technique and sends the caption to the eye piece; and
a processor to run the caption receiver controller program.

13. A portable receiver system of claim 12, further comprising an audio output adapter and wherein, when it is determined that the program type corresponds to a radio program type and the program ID corresponds to a radio program selected for play on the portable receiver system via the user input device, the caption receiver controller extracts an audio segment associated with the caption from the packet using the identified encoding technique and sends the audio segment to the audio output adapter.

14. A portable receiver system of claim 12, further comprising a secondary storage device having a plurality of program files, each program file having one of a plurality of program identifiers, wherein the caption receiver controller further determines whether the program type corresponds to a cinema program type, when it is determined that the program type corresponds to a cinema program type, the caption receiver controller stores the packet in one of the program files having a program identifier corresponding to the identified program ID from the packet.

15. A portable receiver system of claim 14, wherein, when it is determined that the program type corresponds to a cinema program type, the caption receiver controller further determines whether a valid sync code was entered via the user input device, when it is determined that a valid sync code was entered, the caption receiver controller retrieves a caption stream from a first of the program files, the caption stream being derived from each caption in each packet stored in the first program file, extracts a start time from the sync code, identifies a current time and an elapsed time based on the start time and the current time, identifies a point in the retrieved caption stream corresponding to the elapsed time, and sends the caption stream to the eye piece starting at the identified point.

16. A portable receiver system of claim 12, further comprising a secondary storage device having a plurality of program files, each program file having one of a plurality of program identifiers, wherein the caption receiver controller further determines whether the program type corresponds to an RSS program type, when it is determined that the program type corresponds to an RSS program type, the caption receiver controller stores the packet in one of the program files having a program identifier corresponding to the identified program ID from the packet.

17. A portable receiver system of claim 16, wherein, when it is determined that the program type corresponds to an RSS program type, the caption receiver controller further determines whether an option for RSS display is selected via the user input device, when the option for RSS display is selected, the caption receiver controller extracts RSS text from each packet in the program file corresponding to the program ID to form an RSS stream and sends the RSS stream to the eye piece.

18. A portable receiver system of claim 16, wherein, when it is determined that the program type corresponds to an RSS program type, the caption receiver controller further determines whether an option for RSS display is selected via the user input device, when the option for RSS display is selected, the caption receiver controller extracts RSS text from the packet to form an RSS stream and sends the RSS stream to the eye piece.
